(19) United States
(12) Patent Application Publication
(10) Pub. No.: US 2012/0233267 A1
(43) Pub. Date: Sep. 13, 2012

(54) SYSTEMS AND METHODS FOR MESSAGE COLLECTION

(76) Inventor: James Robert Miner, Ashburn, VA (US)

(21) Appl. No.: 13/189,476

(22) Filed: Jul. 22, 2011

Related U.S. Application Data
(60) Provisional application No. 61/451,630, filed on Mar. 11, 2011.

(51) Int. Cl. G06F 15/16

(52) U.S. Cl. 709/206

(57) ABSTRACT

The invention provides systems and methods that process text message content from a user device. The user device is assigned a routing character string. The system is in the form of a tangibly embodied computer. The system inputs an electronic text message from the user device, the electronic text message including text message content and the routing character string. The text message content may be constituted by data generated as a result of, and representative of, characters keyed in to the user device by the user. The text message content including a trig, and the trig including a trick, a command and a bin label. The system includes a processor portion that maintains a bin collection for the user, and performs processing on the text message content relating to a bin in the bin collection.

### RELATED APPLICATION

This application claims priority to U.S. Provisional Patent Application 61/451,630 filed Mar. 11, 2011, the content of which is incorporated herein by reference in its entirety.

### BACKGROUND OF THE INVENTION

Text messaging is widely used by people to communicate in a quick and effective way. However, text messaging, as well as various other communications provided by current known technology, have shortfalls in the benefits such technology provides to users.

### BRIEF SUMMARY OF THE INVENTION

The invention provides systems and methods that process text message content from a user device of a user, the user being a human, the user device assigned a routing character string, the system in the form of a tangibly embodied computer. The system may comprise a communication portion that inputs an electronic text message from the user device, the electronic text message including text message content and the routing character string. The text message content may be constituted by data generated as a result of, and representative of, characters keyed in to the user device by the user, the text message content including a trig, and the trig including a character string of characters in which at least one of the characters is a trick, the trick being a single predetermined character that identifies the character string as the trig, and the trig further including a command and a bin label, and each of the trick, the command and the bin label having been keyed in by the user to the user device and represented in the electronic text message, input by the communication portion, as such. The system may further include a processor portion that maintains a bin collection for the user, the bin collection including a plurality of bins, the processor portion performing processing on the text message content including (1) identifying the user and the bin collection of the user based on the routing character string; (2) identifying the trig contained in the text message content based on identifying the trick contained in the trig; (3) based on identification of the trig, identifying the command, the command dictating particular action to be performed by the processor portion; (4) based on identification of the trig, identifying a bin label in the trig that identifies an identified bin, in the bin collection of the user, upon which to perform the command; and (5) performing the command on the identified bin, the identified bin being one of a plurality of bins a bin collection of the user.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a block diagram of an At-It system in accordance with one embodiment of the invention.

FIG. 2 is an illustrative user interface showing a sequence of text messages, i.e. messages, in accordance with one embodiment of the invention.

FIG. 3 is a diagram showing a text message with trig and content in accordance with one embodiment of the invention.

FIG. 4 is a table showing various types of messages with respective trigs in accordance with one embodiment of the invention.

FIG. 5 is a table showing various further types of messages in accordance with one embodiment of the invention.

FIG. 6 is a diagram parsing out a send message (with send trig) in accordance with one embodiment of the invention.

FIG. 7 is a diagram parsing out a clearbin message (with clearbin trig) in accordance with one embodiment of the invention.

FIG. 8 is a table showing select processing aspects of the At-It system 10 in accordance with one embodiment of the invention.

FIG. 9 is a block diagram showing in further detail the At-It server 200 in accordance with one embodiment of the invention.

FIG. 10 is a diagram that shows further details of user accounts and a bin collection in accordance with one embodiment of the invention.

FIG. 11 is a high level flow chart showing further aspects of the At-It processing in accordance with one embodiment of the invention.

FIG. 12 is a flow chart showing the server processes the message with trig (step 500 of FIG. 11) in further detail in accordance with one embodiment of the invention.

FIG. 13 is a flow chart showing the server (i.e. the bin processing portion 210) processes “add message” (step 520 of FIG. 12) in accordance with one embodiment of the invention.

FIG. 14 is a flow chart showing the server (the bin processing portion 210) processes “send message” (step 530 of FIG. 12) in accordance with one embodiment of the invention.

FIG. 15 is a flow chart showing the server (the bin processing portion 210) processes “clear bin message” (step 540 of FIG. 12) in accordance with one embodiment of the invention.

FIG. 16 is a flow chart showing the server (the bin generation portion 230) processes “add message” (step 550 of FIG. 12) in accordance with one embodiment of the invention.

FIG. 17 is a flow chart showing the server (the bin processing portion 210) processes “delete bin message” (step 560 of FIG. 12) in accordance with one embodiment of the invention.

FIG. 18 is a flow chart showing the server (the bin processing portion 210) processes “add message” (step 570 of FIG. 12) in accordance with one embodiment of the invention.

FIG. 19 is a user interface showing aspects of control messages in accordance with one embodiment of the invention.

FIG. 20 is an illustrative graphical user interface (GUI) showing a user's bin collection and related functionality in accordance with one embodiment of the invention.

FIG. 21 is an illustrative GUI showing the content of a user's “movie bin” and related functionality in accordance with one embodiment of the invention.

FIG. 22 is an illustrative GUI showing functionality related to changing bins in the user's bin collection in accordance with one embodiment of the invention.

FIG. 23 is an illustrative GUI showing functionality related to changing bin settings in accordance with one embodiment of the invention.

FIG. 24 is an illustrative GUI showing functionality related to changing the user's personal information in accordance with one embodiment of the invention.

FIG. 25 is an illustrative GUI showing functionality related to changing the fuzzy logic, which is utilized by the At-It server 200, in processing a user's message in accordance with one embodiment of the invention.

FIG. 26 is a display showing the flow of “add messages” to the At-It server in accordance with one embodiment of the invention.

FIG. 27 is a table setting forth sayings related to the invention in accordance with one embodiment of the invention.

FIG. 28 is a diagram showing the report message of FIG. 2 with trigs vis-à-vis a report message without trigs, in accordance with one embodiment of the invention.

FIG. 29 is a user interface showing aspects of a trig map 2910 in accordance with one embodiment of the invention.

FIG. 30 is a diagram showing the output of content from a user's bin to a social network in accordance with one embodiment of the invention.

FIG. 31 is a diagram showing aspects of creation of a new bin and file structure in accordance with one embodiment of the invention.

FIG. 32 is a flow chart showing fuzzy logic related processing in accordance with one embodiment of the invention.

FIG. 33 is a flowchart illustrating server processing of an incoming telephone call in accordance with one embodiment of the invention.

FIG. 34 is a diagram showing further aspects of trig presentation in a report message from the server 200, in accordance with one embodiment of the invention.

FIG. 35 is a GUI illustrating an allowance adder, in accordance with one embodiment of the invention.

FIG. 36 is a table showing select features of the At-It processing as described herein in accordance with one embodiment of the invention.

### DETAILED DESCRIPTION OF THE INVENTION

Hereinafter, aspects of the “At-It” systems and methods in accordance with various embodiments of the invention will be described.

As used herein, any term in the singular may be interpreted to be in the plural unless otherwise specified, and alternatively, any term in the plural may be interpreted to be in the singular unless otherwise specified.

The systems and methods of the invention provide what is herein characterized as an At-It system. The At-It system includes, in particular, an At-It server. The At-It server may be in the form of a specialized server, i.e. a tangibly embodied specialized computer processing system. In accordance with one embodiment of the invention, the At-It system maintains a respective bin collection for each user. The bin collection for each user includes a plurality of bins to which the user can add content by sending messages to the At-It server, such as by sending text messages to the At-It server. By using particular strings of characters, i.e. “trigs” as characterized herein, the user controls the placement of content of the sent text message into a particular bin. The user may then retrieve aggregated, i.e. collected, content from a particular bin at a desired time. The user may vary the bins in the bin collection. Other channels of communication, such as phone and e-mail, may also be leveraged by the features of the invention. Various other features are provided. The At-It system might be characterized as a tool to assist the user in documenting and then recalling items of information, in conjunction with performing other processing.

The invention is focused on quick and informal communications—which the user can craft and send in seconds, in order to capture thoughts, before such thoughts slip away and are forgotten.

Accordingly, the invention relates, in particular, to leveraging “text messaging” technology to capture pieces of information in a fun, efficient, rewarding and easy way. The invention allows the aggregation of messages of similar content into a bin created for that type of content. For example, the invention might be used in a situation where a child says a cute phrase that a user wishes to capture (e.g. a five-year old saying “why is everything so blue”); the name of a song that the user wants to remember (to search and download from ITUNES at a later and more convenient time); or a title from a movie preview that looks good (and the user wants to order via NETFLIX or PAY PER VIEW when the user gets a chance on the weekend). In each situation, the user would add content to a particular bin, so as to remember the information at some later time. A clever saying of a five year old, at a busy child's birthday party, may well be forgotten in minutes, unless somehow captured. The invention addresses such situation, and many others.

Illustratively, another situation might be that a user has rented the movie IRON MAN 2 and one of the previews on the DVD is for the movie “INCEPTION.” Thinking INCEPTION looks like a good movie to see, the user pulls out her smartphone, and keys in the text “add@movie—saw preview for inception tonight, looks good” in a text message. The user addresses the text message to the text number for the “At-It server”. That is, the At-It server has a unique number, or other sequence of characters, to which text messages may be sent.

The At-It server maintains an “At-It account” for the particular user, as well as for other users. The At-It account of the user includes the user's phone number, i.e. the user's text number” and a bin collection of the user. The user's account also includes various other particulars of the user needed to perform At-It related processing.

At some later time, e.g. on movie night a couple weeks later, the user wants the At-It system to remind her of all the movies she has “At-ed” (pronounced “ated”). The user sends a predetermined text message to the At-It server—such as “send@movie”. The At-It server (in response) aggregates all the add@movie text messages (that the server has previously received from the user and put into the “movie bin”), and sends the aggregated text messages back to the user as a text message. The user is thus provided aggregated content that the user can utilize in a beneficial manner. In this example, the user can use the aggregated content, accumulated over time, to remember movies of interest to her.

The character strings “add@movie” and “send@movie” are herein referred to as “trigs”. The composition of a trig depends on the particular command , as well as the particular bin the command acts upon. As noted above, an “add” message for the user's movie bin might be in the form of “add@movie”—for movies to remember. Other “add” messages might include “add@cute” for a bin for cute sayings of kids; “add@songs” for a bin for songs; and so forth. Each “add message” (sent from the user to the At-It server) includes the trig as well as the desired content the user wants to remember. Other types of text messages to the At-It server may only include a trig. For example a “send message” from the user to the server only includes a trig.

Based on the content of a trig in each “add” message, the At-It server adds the content in the text message to a particular bin in the user's bin collection. In accordance with one embodiment of the invention, the particular placement of the trig (by the user) in an add message does not matter. Thus, regardless of whether the user puts the trig, before the content, after the content, or in the middle, the server will still identify the trig based on the @ in the trig. The bins may be logically named to reflect the content intended for each bin. The user may be provided the ability to rename bins (or add bins)—to make the bin names more logical for them, and easier to remember. The At-It server thus aggregates, over time, all the text messages that the user has designated to a particular bin. The user may then retrieve that aggregated content by sending a “send message” to the At-It server. As noted above, “send@movie” is an example of a send message.

Accordingly, the trigs are of a predetermined format. The predetermined format allows the user to craft a text message with trig so as to generate the desired processing. The predetermined format allows the At-It system to be programmed to perform the desired processing in response to receiving a particular text message with trig from the user. As noted above, the particular content of a trig will vary based on the command desired by the user and the particular bin that the command is to be applied to, i.e. in performing the desired processing.

In more specific explanation, a trig of the invention includes a command, a trick, and a bin label. The invention, as characterized herein, utilizes the “@” key for the “trick”. The “@” key is a primary key on some smartphones, and thus easily accessible by the user. Based thereon, some of the terminology set forth herein evolved. However, it is appreciated that another character on a phone (or other user device) might be used equally as well for the trick, and other corresponding terminology similarly coined. The invention may include various other related features. For example, suitable character strings, i.e. other trigs, may be sent to the At-It server to delete “ated” items or create new bins, for example. The invention is particularly focused at text messages. However, the processing concepts discussed herein might well be addressed to other communications, such as phone and e-mail messaging communications. For example, the user may send a text (with trig) to the At-It server telling the At-It server to send content from a particular bin to the user via text message, e-mail, on-line document and/or phone, for example. In addition, or alternatively, the text message with trig might tell the At-It system to send particular content from a bin to a third person (such as a friend of the user). The user and third persons may be sent the content via different or the same communication channels, based on user preference. Processing might include converting content in the bin, i.e. the data stored in the bin, to a text message, e-mail, and/or audio, such as a WAV (Waveform Audio File Format) file. Communications may be exchanged between the At-It server and the user regarding the status of the user's at-its, e.g. how many at-its have been collected, as well as other parameters or metrics of the processing. As described below, content may be added to bins via communication channels other than text message, such as telephone call and e-mail, for example.

Various further aspects of the At-It invention are described below.

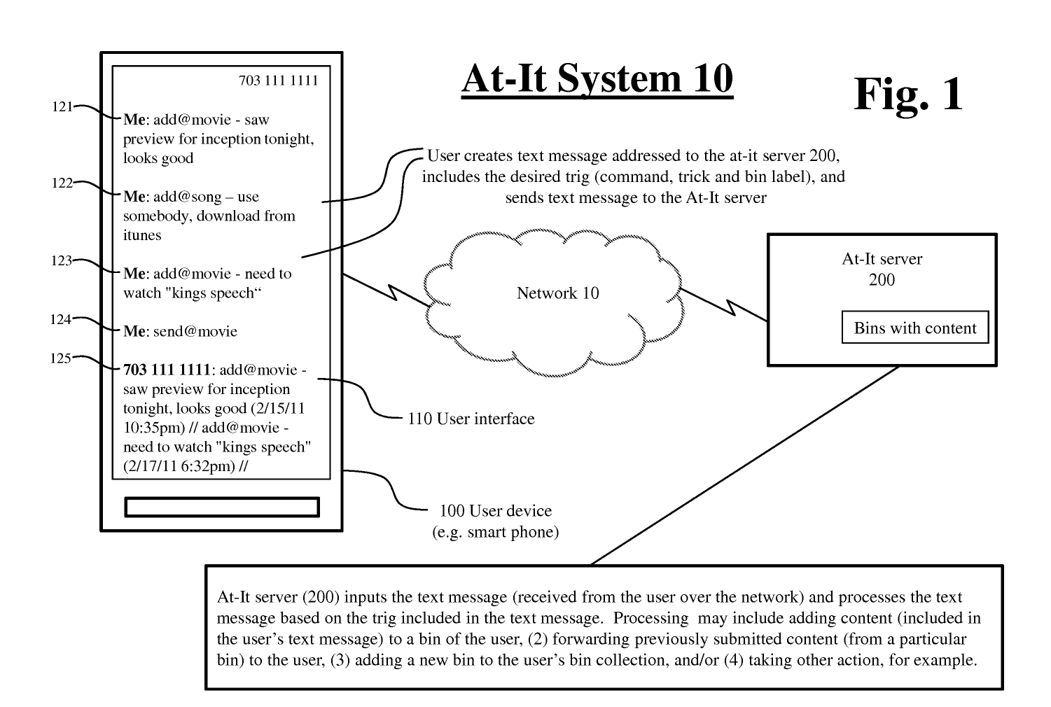

FIG. 1 is a block diagram of an At-It system 10 in accordance with one embodiment of the invention. The At-It system 10 includes an At-It server 200 in the form of a tangibly embodied computer processing system. As described herein, the At-It server 200 performs various processing in practice of the invention, and in particular maintains bin collections associated with respective users. Such maintenance of bin collections may include adding content to a specified bin, pulling content from a specified bin, deleting content from a specified bin, adding bins, and deleting bins, for example. Various other features are described herein.

The At-It system 10 also includes various user devices 100. In accordance with one embodiment of the invention, the user device 100 is a smartphone or some other device that is provided with messaging and communication capability, and in particular, text messaging capability. It is appreciated that the number of user devices 100 in the At-It system 10 may reach the thousands or millions. Relatedly, it is appreciated that there may be multiple At-It servers 200 in the At-It system 10. Such plurality of servers might work collectively or independently relative to each other. The At-It server 200 communicates with the various user devices 100 over a suitable network 10. For example, the network 10 may be in the form of the Internet.

In accordance with embodiments described herein, the At-It system 10 is interpreted as including user devices 100. It is appreciated that the At-It system 10 may utilize known user devices, and known network architecture, with novelty of the invention residing in the server 200 and the manner in which the user uses his or her user device. However, in accordance with some embodiments of the invention, the user device itself may be provided with novel features.

As shown in FIG. 1, the At-It server 200 inputs a text message (received from the user over the network) and processes the text message based on the trig included in the text message. More specifically, the user creates a text message addressed to the at-it server 200, includes the desired trig (with command, trick and bin label), and sends such text message to the At-It server. Responsive processing by the server 200 may include adding content (included in the user's text message) to a bin of the user, (2) forwarding previously submitted content (from a particular bin) to the user, (3) adding a new bin to the user's bin collection, and/or (4) taking other action, for example.

As shown in FIG. 1, the user interface 110 of the user device 100 reflects three add messages (121, 122, 123) sent by the user. Such add messages result in content being added to a bin in the user's bin collection, and specifically, in this example, to the user's movie bin (resulting from text messages 121 and 123) and to the user's song bin (resulting from text message 122). The text message 124 constitutes a send message. In this example, the send message 124 requests the server to send content that is disposed in the user's movie bin. In response, the server 200 sends the user the text message 125. The text message 125 may be characterized as a “report message”, and includes the content that was previously sent to the server in the text messages, i.e. the “add” messages, 121 and 123. Further details are described below.

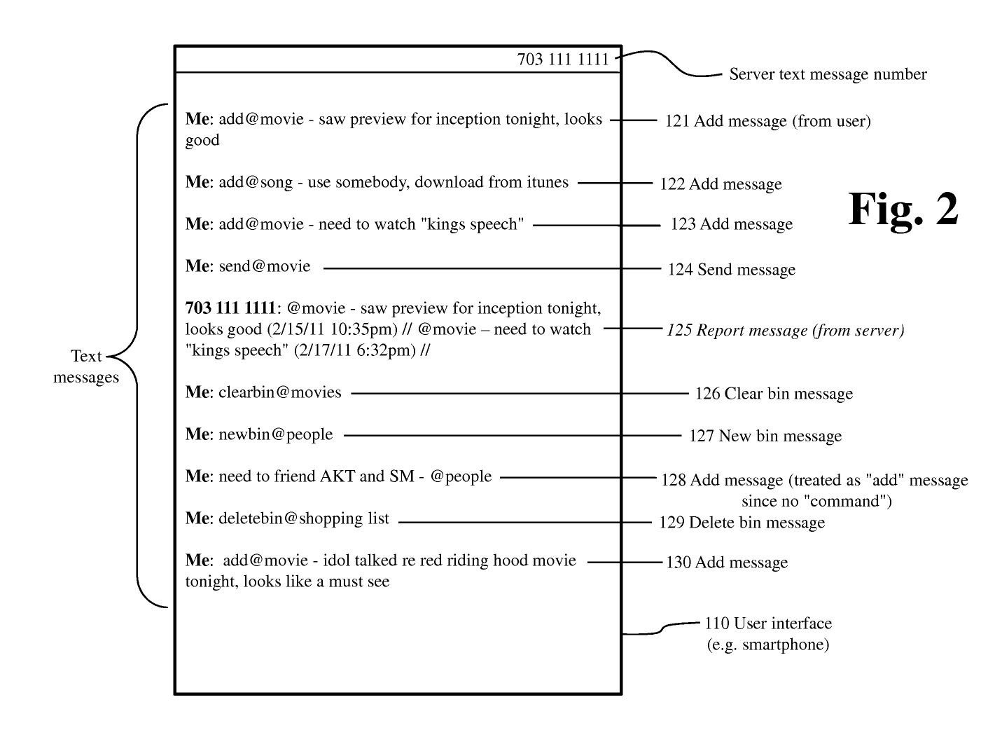

FIG. 2 is an illustrative user interface 110 showing a sequence of text messages, i.e. messages, in accordance with one embodiment of the invention. The text messages 121-125 are described above with reference to FIG. 1. In this example, all of the text messages shown in the user interface 110 of FIG. 2 are generated by the user, except for the report message 125. The report message 125 is generated and sent by the server 200, in response to the user's send message 124.

FIG. 2 shows various further messages in addition to those described above with reference to FIG. 1. The clearbin text message 126 instructs the server 200 to clear, i.e. delete the content in the specified bin, in this case the movies bin. The newbin text message 127 instructs the server 200 to create a new bin in the user's bin collection, in this case create a new bin “people”. The text message 128 does not include a complete trig. In accordance with one embodiment of the invention, the message 128 may be treated as an add message and placed in a catchall bin. In other embodiments, fuzzy logic may be employed so as to place the message 128 in the user's people bin. Various further details of fuzzy logic are described below.

FIG. 2 also shows the text message 129. The message 129 is a delete bin message. That is, the message 129 does not merely delete the contents of the bin (as does text message 126). Rather, the message 129 deletes the entire bin, such as in the situation where the user no longer needs the bin.

Lastly, FIG. 2 shows the add message 130.

Various further details of the various types of text message and related processing are described below.

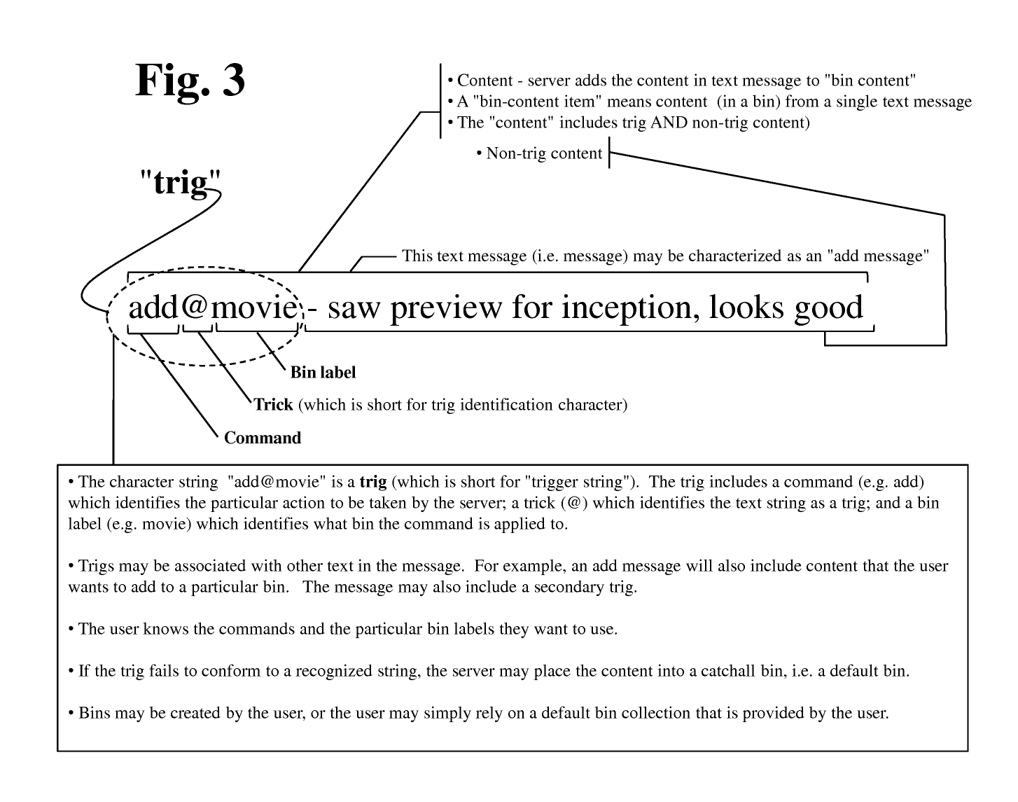

FIG. 3 is a diagram showing a text message in accordance with one embodiment of the invention. The text message of FIG. 3 may be characterized as an “add message”.

In the message of FIG. 3, the character string “add@movie” is a trig (which is short for trigger string). The trig includes a command (e.g. add) which identifies the particular action to be taken by the At-It server; a trick (the character @) which identifies the character string as a trig; and a bin label (e.g. movie) which identifies what bin the command is applied to. In this example illustrating an “add message,” the “bin label” tells the server what bin the content of the text message will be placed. Accordingly, as reflected in this example of FIG. 3, trigs may be associated with other text in the message, i.e. non-trig content as shown in FIG. 3. In particular, an add message will include non-trig content that the user wants to remember. Non-trig content is characterized as any character string in a text message that does not include a trick, i.e. that does not include an @. In the add message of FIG. 3, the content the user wishes to remember is “—saw preview for inception tonight, looks good”. As characterized herein, a “bin-content item” means content (in a bin) from a single text message.

As described herein, the particular placement of the trig in an add message does not matter in accordance with some embodiments of the invention. In accordance with other embodiments, certain placement of the trig will trigger certain processing. In accordance with some embodiments of the invention, the trig should be separated from the non-trig content by spaces.

In more complex uses, the text message sent from the user to the At-It server may also include a secondary trig. A secondary trig might be characterized as modifying the main trig. For example, a secondary trig might tell the At-It server to only pull content (in the bin) from a particular time window, such as between July 1 and July 11. Indeed, any number of trigs might be utilized so as to command the server to perform desired processing, assuming the server is programmed to act on such commands.

In practice of the invention, the user knows the commands that are available, as well as knows the bins in the user's bin collection. Accordingly, in a text message from the user to the At-It server, the user recalls (from memory and/or with reference to notes or other materials) the desired command and the desired bin, and crafts a trig to include such (e.g. add@movie). If a trig received from a user fails to conform to a recognized character string, the server may place the content into a catchall bin, i.e. a default bin. Alternatively, as described herein, the At-It server may apply fuzzy logic to ascertain which bin was intended by the user and/or the command the user intended. In response to a suitable request by the user, the server 200 may be provided to generate and output relevant information to the user, such as a listing of bins, listing of commands, metrics relating to bin content, date information, or other information. For example, the user may have forgotten his bins, and may send the server 200 a request for the server to send him a listing of all bins in his bin collection.

Bins may be created by the user, or the user may simply rely on a default bin collection that is provided by the server 200. That is, when the user first signs on to the At-It service as described herein, the At-It server 200 may provide a very basic bin collection and list of commands, i.e. for the user to get familiar with the system. The user may then start to modify the bin collection as he or she desire. Indeed, a bin collection may have a large number of bins depending on the user's needs, desire to remember and/or desire to keep track of information. In accordance with one embodiment of the invention, more advanced processing of the invention may indeed involve sub-bins, and corresponding associated commands, or other groupings of bins. In accordance with embodiments of the invention, a particular trig in a text message may result in action vis-à-vis multiple bins. For example, in a more complex use, the add message “send@movie,people” may result in the server sending content (to the user) from both the movie bin and the people bin. Such content may be sent in some predetermined manner as desired.

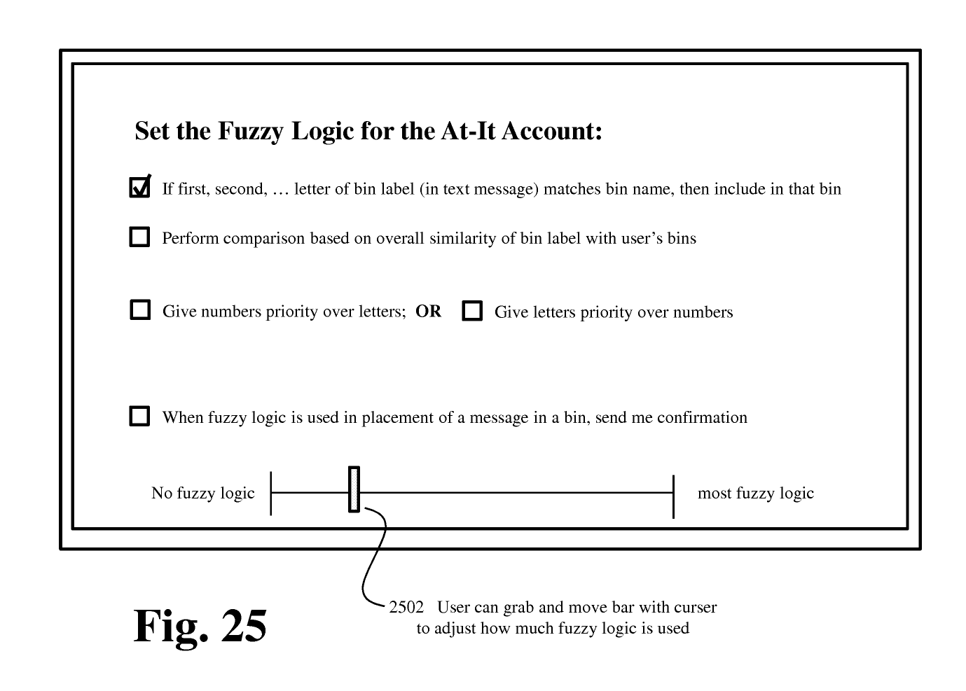

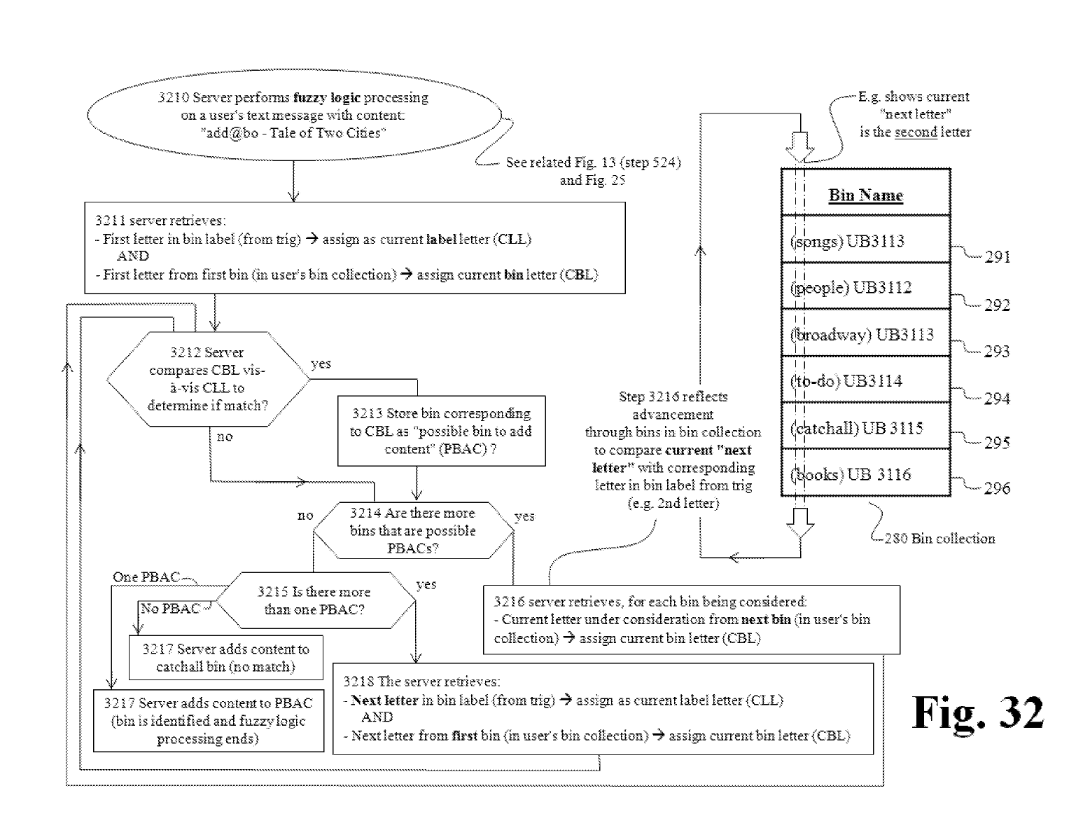

With further reference to the use of fuzzy logic, it is appreciated that various default processing may be used by the At-It server 200. Indeed, the user might come to rely on such default processing (as described herein) as such may increase the efficiency he or she can work at. Accordingly, one type of default processing is the fuzzy logic processing noted above. Further aspects of “fuzzy logic” type processing are described below with reference to FIG. 25 and FIG. 32. For example, the At-It server 200 may be provided to know (and the user may or may not know) that a trig in a text message to the server “ad@m see social network” will be interpreted as “add@movie see social network” by the At-It server 200. Accordingly, such text constitutes a quick way for the user to place content into her or his movie bin, without having to type out the full bin name, for example. Based on fuzzy logic processing, the server 200 maps the “ad” in the user's trig to the command “add”. Based on fuzzy logic processing, the server also maps the bin label “m” to the bin “movie”.

Also, by providing users with the capability to create his or her own bins, he or she can evolve a bin collection that is very intuitive to them, and highly conducive to the use of fuzzy logic, for the particular user. For example, by design of the user, all of the user's bins might have different first letters in the name—such that the user would never have to type/text the full name. Rather, the user would rely on fuzzy logic of the At-It server 200 and only type (in a trig) the first letter of a bin name.

Accordingly, the invention highly leverages existing text messaging (and other communication technologies) in conjunction with the user's adeptness and memory, which might be assisted by reference materials, i.e. a cheat sheet of sorts to remind the user of bins and trigs, for example. The invention provides a highly useful, efficient, and fun way to retain information from everyday life, for example.

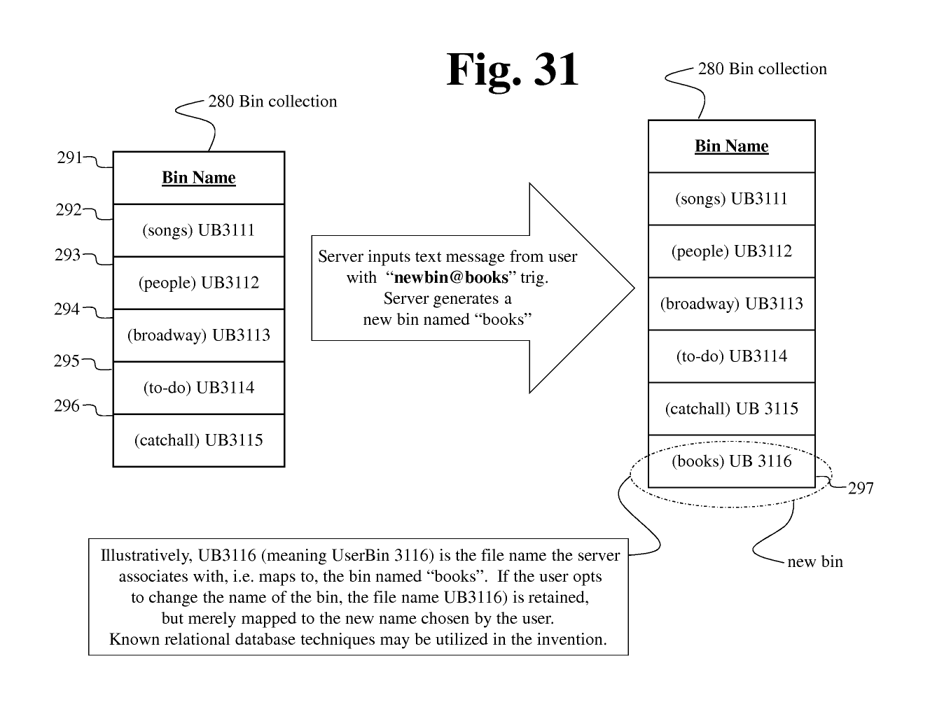

As described further below, the user may modify her or his bin collections and the names of her or his bins. In particular, as described below with reference to FIG. 31 in accordance with one embodiment of the invention, the server may retain an identity of a bin that is static. That static identity may be mapped to a corresponding bin name, which is presented to the user (and by which the user knows the bin). Further details are described below.

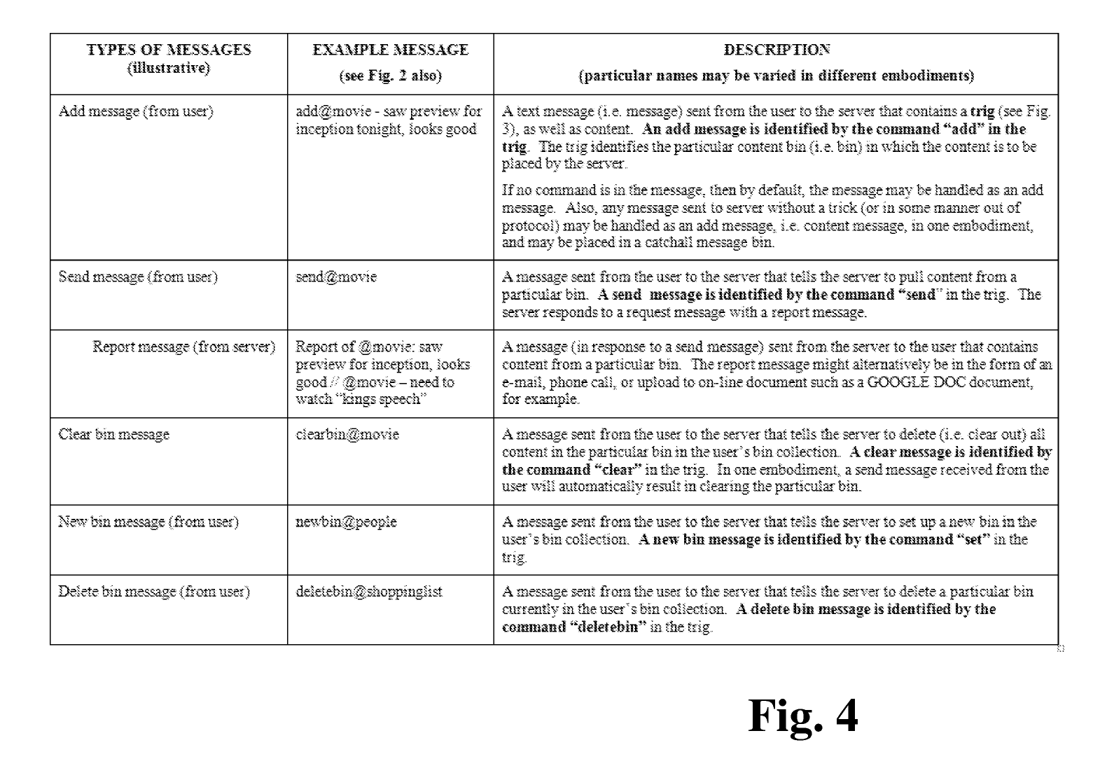

FIG. 4 is a table showing various types of messages with respective trigs in accordance with one embodiment of the invention. The trigs in the messages of FIG. 4 might be characterized as “primary trigs” in that no other trig is needed (in the particular text message) for the server to process the text message.

FIG. 4 shows an “add message” (from user): add@movie—saw preview for inception tonight, looks good. Such message may be in the form of a text message (i.e. message) sent from the user to the server that contains a trig (see FIG. 3), as well as content. An add message is identified by the command “add” in the trig. The trig identifies the particular content bin (i.e. bin) in which the content is to be placed by the server. If no command is in the message, then by default, the message may be handled as an add message. Also, any message sent to server without a trick (or in some manner out of protocol) may be handled as an add message, i.e. content message, in one embodiment, and may be placed in a catchall message bin.

FIG. 4 shows a send message (from user): send@movie. Such message may be in the form of a message sent from the user to the server that tells the server to pull content from a particular bin. A send message is identified by the command “send” in the trig. The server responds to a request message with a report message.

FIG. 4 shows a report message (from server): Report of @movie: saw preview for inception, looks good II @movie—need to watch “kings speech”. Such message may be in the form of a text message (in response to a send message) sent from the server to the user that contains content from a particular bin. The report message might alternatively be in the form of an e-mail, phone call, or upload to on-line document such as a GOOGLE DOC document, for example.

FIG. 4 shows a clear bin message: clearbin@movie. Such message may be in the form of a message sent from the user to the server that tells the server to delete (i.e. clear out) all content in the particular bin in the user's bin collection. A clear message is identified by the command “clear” in the trig. In one embodiment, a send message received from the user will automatically result in clearing the particular bin.

FIG. 4 shows a new bin message (from the user): newbin@people. Such message may be in the form of a message sent from the user to the server that tells the server to set up a new bin in the user's bin collection. A new bin message is identified by the command “set” in the trig.

FIG. 4 shows a delete bin message (from user): deletebin@shoppinglist. Such message may be in the form of a message sent from the user to the server that tells the server to delete a particular bin currently in the user's bin collection. A delete bin message is identified by the command “deletebin” in the trig.

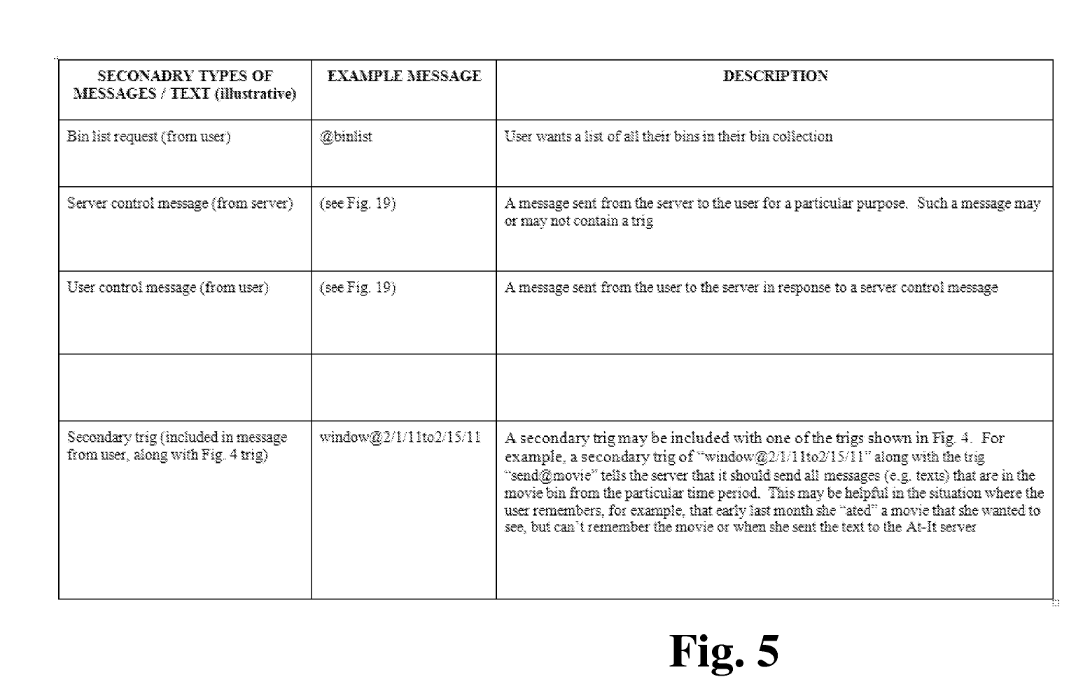

FIG. 5 is a table showing various further types of messages in accordance with one embodiment of the invention.

FIG. 5 shows a bin list request (from user): @binlist. A user may send this message to the server 200 if the user wants a list of all her bins in her bin collection. That is, a “bin list request” message from the user to the server will result in a text message back from the At-It server 200 with a list of the user's bins. Thus, if the user forgot her bins, she could send the server a bin list request.

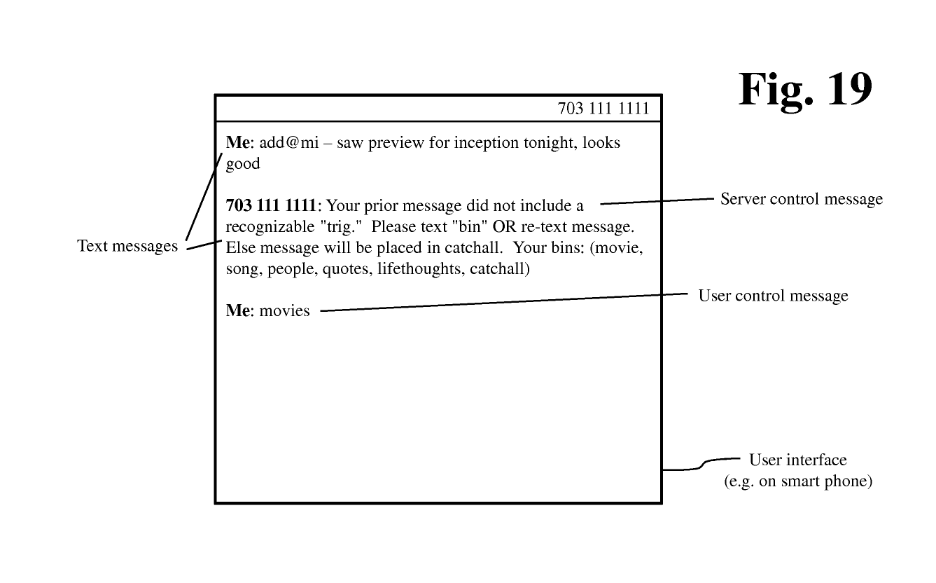

FIG. 5 shows a server control message (from server). Further details are described below with reference to FIG. 19. This type message is sent from the server to the user for a particular purpose. Such a message may or may not contain a trig

FIG. 5 shows a user control message (from user). This type message is sent from the user to the server in response to a server control message, in accordance with one embodiment of the invention.

FIG. 5 shows a secondary trig (included in message from user, along with FIG. 4 trig): window@2/1/11to2/15/11. A secondary trig may be included with one of the trigs shown in FIG.

4. For example, a secondary trig of “window@2/1/11to2/15/11” along with the trig “send@movie” tells the server that it should send all messages (e.g. texts) that are in the movie bin from the particular time period. This may be helpful in the situation where the user remembers, for example, that early last month she “ated” a movie that she wanted to see, but can't remember the movie or when she sent the text to the At-It server.

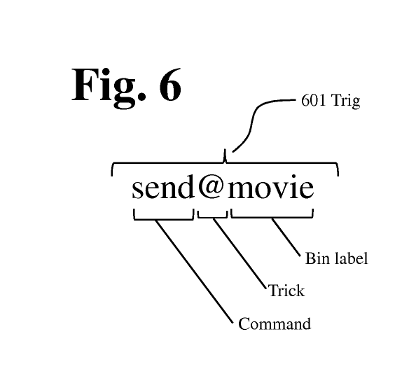

FIG. 6 is a diagram parsing out a send message (with send trig) in accordance with one embodiment of the invention. The message of FIG. 6 tells the At-It server 200 to send all content that is currently in the user's “movie” bin. The trig 601 of FIG. 6 includes a command, a trick, and a bin label as shown. The trig 601 constitutes the entirety of the text message sent from the user, i.e. the user device, to the server 200—to request the server to send the requested content to the user.

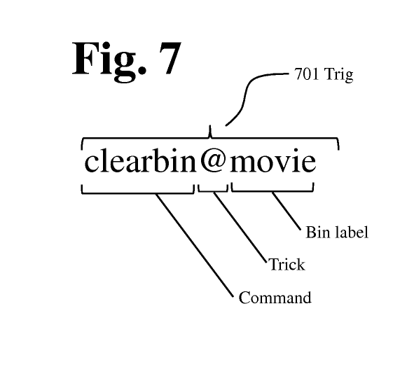

FIG. 7 is a diagram parsing out a clearbin message (with clearbin trig) in accordance with one embodiment of the invention. The message of FIG. 6 tells the At-It server 200 to clear out, i.e. delete, all content that is currently in the user's movie bin. The trig 701 of FIG. 7 includes a command, a trick, and a bin label as shown. The trig 701 constitutes the entirety of the text message sent from the user, i.e. the user device, to the server 200—to request the server to delete the content from the specified bin, i.e. from the “movie” bin.

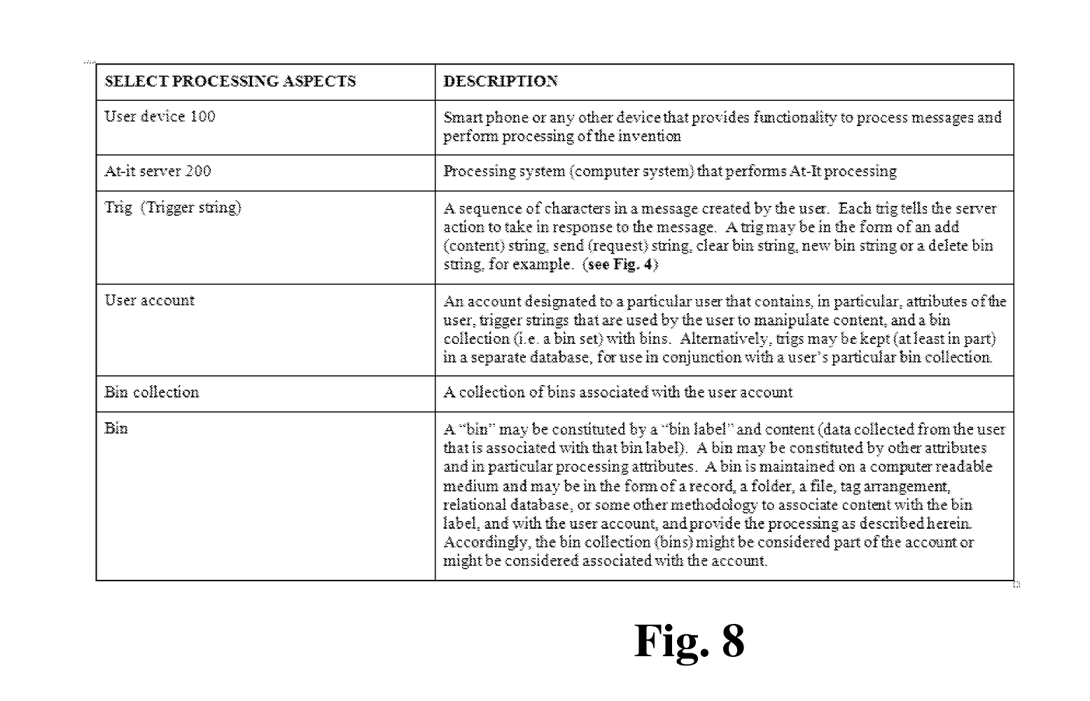

FIG. 8 is a table showing select processing aspects of the At-It system 10 in accordance with embodiments of the invention.

A user device 100 as described herein may be in the form of a smart phone, computer or any other device that provides functionality to process messages and perform processing of the invention.

An At-it server 200 as described herein may be in the form of a processing system (, i.e. a computer system) that performs At-It processing as described herein.

A “trig” (trigger string) as described herein may be in the form of a sequence of characters in a message created by the user. Each trig tells the server action to take in response to the message.

A trig may be in the form of an add (content) string, send (request) string, clear bin string, new bin string or a delete bin string, for example.

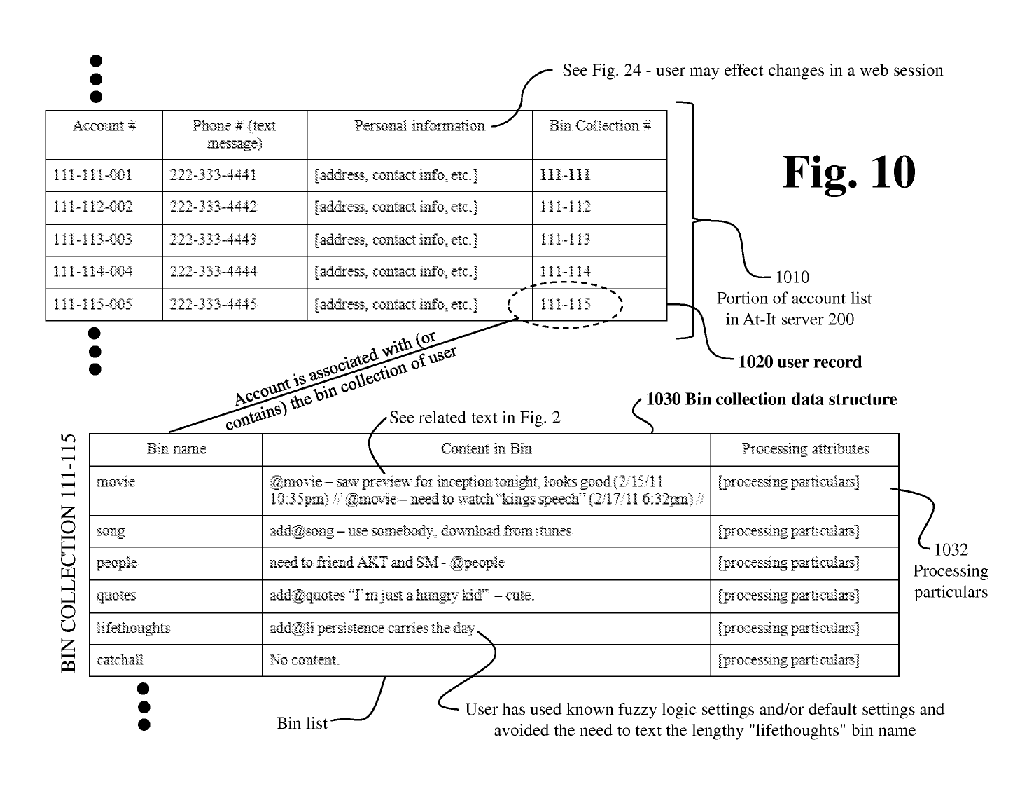

A “user account” as described herein may be in the form of an account designated to a particular user that contains, in particular, attributes of the user, trigger strings that are used by the user to manipulate content, and a bin collection (i.e. a bin set) with bins. Alternatively, trigs may be kept (at least in part) in a separate database, for use in conjunction with one or more a user's particular bin collection. Further aspects of embodiments are described below with reference to FIG. 10.

A “bin collection” as described herein may be constituted by a collection of bins associated with the user account.

A “bin” as described herein may be constituted by a “bin label” and content (data collected from the user that is associated with that bin label). A bin may be constituted by other attributes and in particular processing attributes. A bin is maintained on a computer readable medium and may be in the form of a record, a folder, a file, tag arrangement, relational database, or some other methodology to associate content with the bin label, and with the user account, and provide the processing as described herein. Accordingly, the bin collection (bins) of a particular user might be considered part of the account of the user or might be considered associated with the account of the user. For example, the bin collection of a user, including the bins disposed in the bin collection, might be mapped to the user account in some suitable manner.

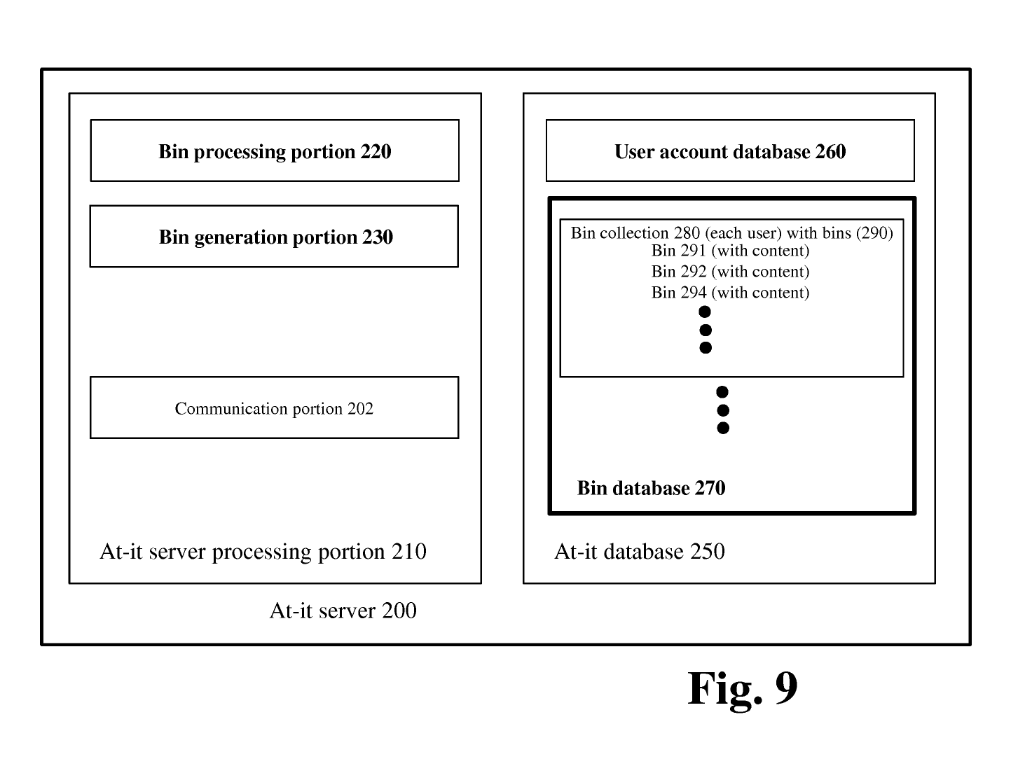

FIG. 9 is a block diagram showing in further detail the At-It server 200 in accordance with one embodiment of the invention. As shown, the At-It server 200 includes an At-It server processing portion 210 and an At-It database 250. The At-It server processing portion 210, a processor, performs various processing as described herein. The At-It database 250 contains the various data used by, input by, and generated by, for example, the At-It server 200.

The At-It server processing portion 210 contains specialized processing portions that perform particular types of processing. The specialized processing portions include the communication portion 202, the bin processing portion 220 and the bin generation portion 230.

The communication portion 202 performs the input and output of text message, e-mail, and phone, upload to third party database, and other communications, for example. The communication portion 202 may also handle converting data as needed. For example, in accordance with one embodiment of the invention, data from an input text message may be converted to another format for storage in the bin collection of the user, i.e. for storage in the bin database 270. The communication portion 202 may also handle converting data in the bin database 270 to a particular format for output of data via a particular communication channel. Accordingly, the communication portion 202 may handle the needed conversion of data to effect the various processing as described herein, involving various communication channels.

The bin processing portion 220 performs various processing associated with maintenance and other operations of the bins in a bin collection of a user, for example, in accordance with one embodiment of the invention. The bin generation portion 230 performs processing associated with generation of a bin, i.e. at the request of a user. In accordance with one embodiment of the invention, the bin generation portion 230 may include template bin collections that a user may choose from. Thus, a template bin collection for a college student might include different bins vis-à-vis a template bin collection for a high school student. The user might choose the preferred template bin collection and then modify her bin collection to her liking.

The At-It database 250 includes a user account database 260 and a bin database 270. In accordance with this embodiment of the invention, the user account database 260 contains various details of a user's account. Each user account is mapped, or otherwise associated, with a bin collection 280 in the At-It database 250, as described herein.

FIG. 10 is a diagram that shows further details of user accounts and a bin collection in accordance with one embodiment of the invention.

FIG. 10 shows a portion of an account list 1010 showing accounts of a plurality of users. The vertical series of dots as shown in FIG. 10, and used elsewhere herein, reflect that only a portion of the particular item is shown.

The account list 1010 includes a user record for each respective user. Illustratively, FIG. 10 shows the user record 1020. The user record 1020 includes an account number, the user's phone number (or other number the user uses for text messaging), personal information (such as address information, other contact information (e.g. e-mail, landline phone numbers)), and a bin collection number. In accordance with this embodiment of the invention, the bin collection number (111-115) maps into a bin collection data structure 1030. Accordingly, the bin collection data structure 1030 is associated with the user record 1020—such that the bin collection data structure 1030 may be retrieved to perform processing of a text message from the user 111-115-005. The user record 1020 and the bin collection data structure 1030, as well as other data structures utilized in the invention, may utilize relational database processing and other known database processing methodologies and techniques.

The bin collection data structure 1030 includes the bin names of the user's bins, as well as content in each respective bin. Further, each bin may be associated with processing particulars 1032, as shown in FIG. 10. The processing particulars 1032 for each bin control various processing attributes of the particular bin including: the destination that the server sends report messages; the channel that report message are sent, the position of trigs in bin-content items in a report message; whether trigs are included in a report message; whether any third persons are sent report messages; how many bin-content items should be retained in a particular bin at one time; whether there is rollover of bin-content item in some time period, i.e. after 3 months a bin-content item is deleted; whether there is any delay in sending a report message; password or other information required to access the bin collection and/or respective bins in the bin collection; any particular manner in which bin-content item should be aggregated; and web page related user preferences, for example. Various other operating parameters may be included in the processing particulars 1032, as needed or desired, to perform the processing as described herein.

It is appreciated that the processing particulars 1032 of different bins in a user's bin collection may be the same or may be different. A user may be provided control over some processing particulars 1032, e.g. in the form of user preference, while other processing particulars 1032 are dictated to the user. The user may be provided the ability to change certain processing particulars 1032 bin by bin, or in some global manner. Various further details of the processing particulars 1032, in accordance with embodiments of the invention, are described below.

In accordance with one embodiment of the invention, the user may rate bin-content items in some manner. The rating, in accordance with one embodiment of the invention, dictates particular processing to be performed by the server. For example, a suitable send message might dictate that the server should only pull content possessing higher than a particular rating, and send such in a report message to the user.

It is appreciated that the user's account number may indeed be the same as the user's phone/text number. However, such may not be desirable in that a user might have multiple text numbers associated with the same bin collection or account, or may want to change her number at some point in time.

In accordance with one embodiment of the invention, a bin collection may indeed be associated with multiple user's devices, i.e. such that a husband and wife might populate bins in the same bin collection. The trigs used by both users might be the same or might be different. That is, the At-It server 200 would know which user the text message was coming from (based on the user's phone/text number) and analyze the included trig based on that user's trig list and bin collection, i.e. the server would analyze the commands and bin labels that are associated with that user.

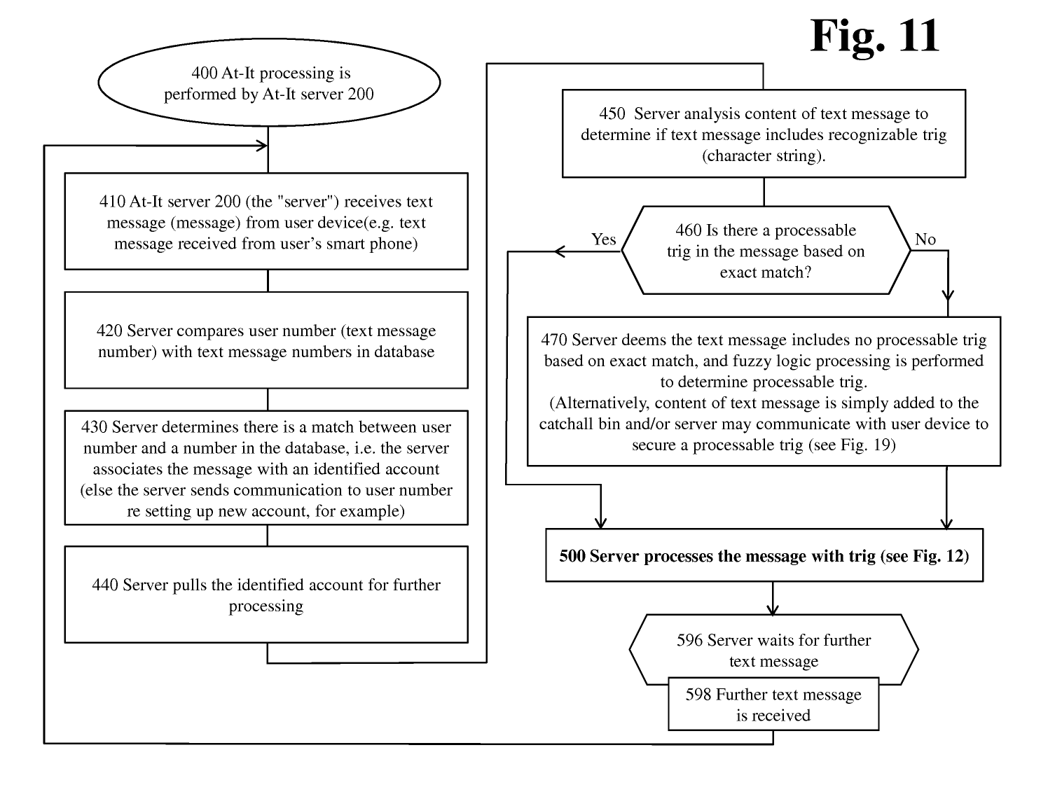

FIG. 11 is a high level flow chart showing further aspects of the At-It processing in accordance with one embodiment of the invention. As shown, the processing of FIG. 11 starts in step 400 and passes to step 410. In step 410, the server 200 receives a text message from a user device having a text message number. For example, the server receives a text message received from a user's smart phone. Then, the process passes to step 420. In step 420, the server compares the user number, that the message was texted in from, with text message numbers in the database of the server 200. The process then passes to step 430.

In step 430, the server determines that there is a match between the user number and a number in the database. That is, based on the user's text message number, the server associates the message from the user with an identified account of the user. In a situation where the server 200 cannot identify the number from which the text message originated, the server may send a communication back to the user. For example, the server may send a communication to such user regarding setting up a new account, i.e. since the user is not currently registered based on the number from which the user texted.

After step 430 of FIG. 11, the process passes to step 440. In step 440, the server pulls the identified account for further processing. Then, in step 450, the server analysis the content of the text message to determine if the text message includes a recognizable trig, i.e. a recognizable character string. Then, the process passes to step 460. In step 460, the server determines whether there is a processable trig in the message based on an exact match.

More specifically, in step 460, the server compares the trig received in the text message vis-à-vis commands and bin labels that are associated with such user (as stored in the At-It database 250). More specially, the server parses out the command (in the text message received from the user) and determines whether such command matches a command stored in the database, and which is associated with the particular user. In parallel, the server parses out the bin label from the text message and determines if such bin label matches a bin stored in the database, and which is associated with the particular user. Relatedly, different users may commonly possess different bins and may possess different commands. In accordance with one embodiment of the invention, it is likely that difference in bins will be more substantial than difference in commands. In particular, commands may be substantially more standardized within the At-It system, than bin names.

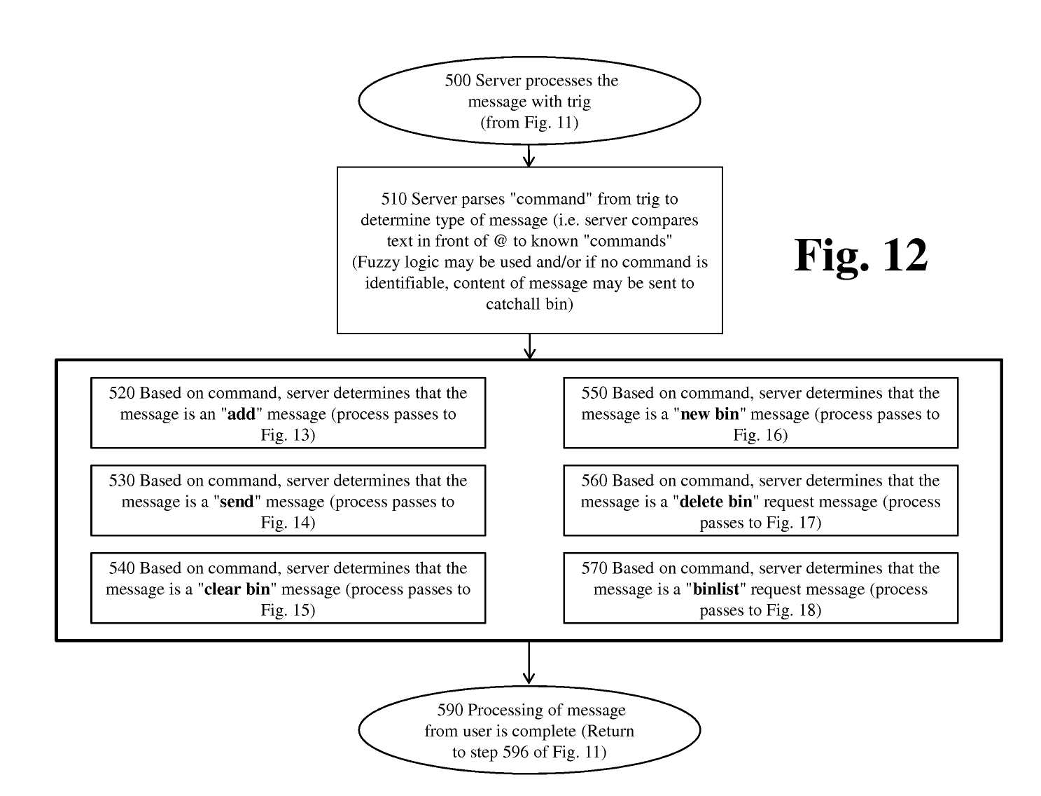

In step 460, the server determines if there is an exact match for both the command, in the trig, as well as the bin label in the trig. If yes in step 460, then the process passes to step 500. In step 500, the server processes the message with trig. Further details of the processing of step 500 are shown in FIG. 12 and described below.

On the other hand, if no in step 460, i.e., there is not a processable trig in the message based on an exact match, then the processing passes to step 470. In step 470, the server deems that the text message includes no processable trig based on an exact match. As a result, fuzzy logic processing is performed to determine if a processable trig may be ascertained. Alternatively, the content of the text message is simply added to the catchall bin in the user's bin collection. In conjunction with such addition to the user's catchall bin, the server may communicate such disposition to the user device.

Alternatively, the server may communicate with the user device to secure a processable trig. Further details regarding such further communications are described with reference to FIG. 19 below.

After step 470 of FIG. 11, the process passes to step 500.

As noted above, in step 500, the server processes the message with trig. Further details of the processing of step 500 are described below with reference to FIG. 12. After step 500 of FIG. 11, the process passes to step 596. In step 596, the server waits for a further text message. Then, as reflected in step 598, at some point in time, the server receives a further text message and processing returns to step 410. Thereafter, processing is performed as described above.

FIG. 12 is a flow chart showing the server processes the message with trig (step 500 of FIG. 11) in further detail in accordance with one embodiment of the invention. As shown, the processing of FIG. 12 starts in step 500 and passes to step 510.

In step 510, the server parses the “command” from the trig to determine the type of message. In other words, the server compares the text in front of the @ (in the trig) to known commands the server associates with the user in the database 270. Fuzzy logic may be utilized to determine the command. If no command is identifiable, content of the message may simply be sent to the “catchall” bin in the user's bin collection. It is appreciated that multiple parsing of the user's text message, as described in step 510 of FIG. 12 and step 460 of FIG. 11 for example, may be combined in some manner as desired, so as to perform more efficient processing.

The processing of the server after step 510 of FIG. 12 depends on the particular “command” identified from the trig. That is, steps 520, 530, 540, 550, 560, and 570 are performed in the alternative, depending on the particular command identified in the trig from the user device.

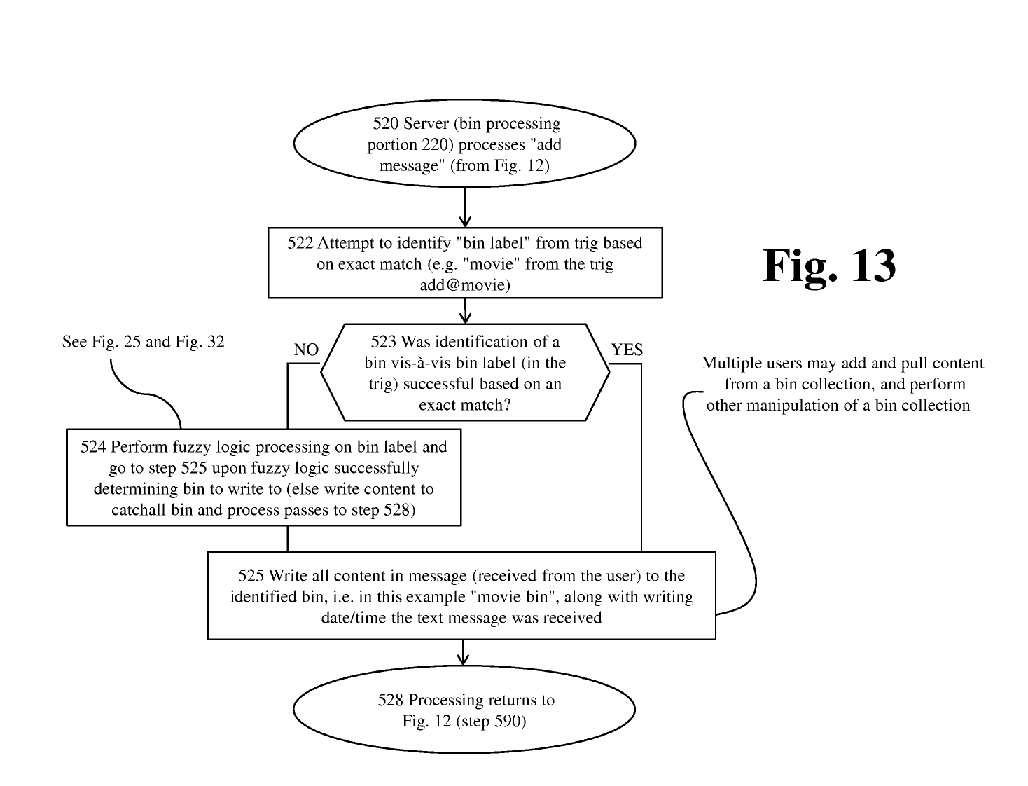

As reflected in step 520, based upon the command in the trig, the server 200 determines that the message is an “add” message. Accordingly processing passes to FIG. 13 as described below.

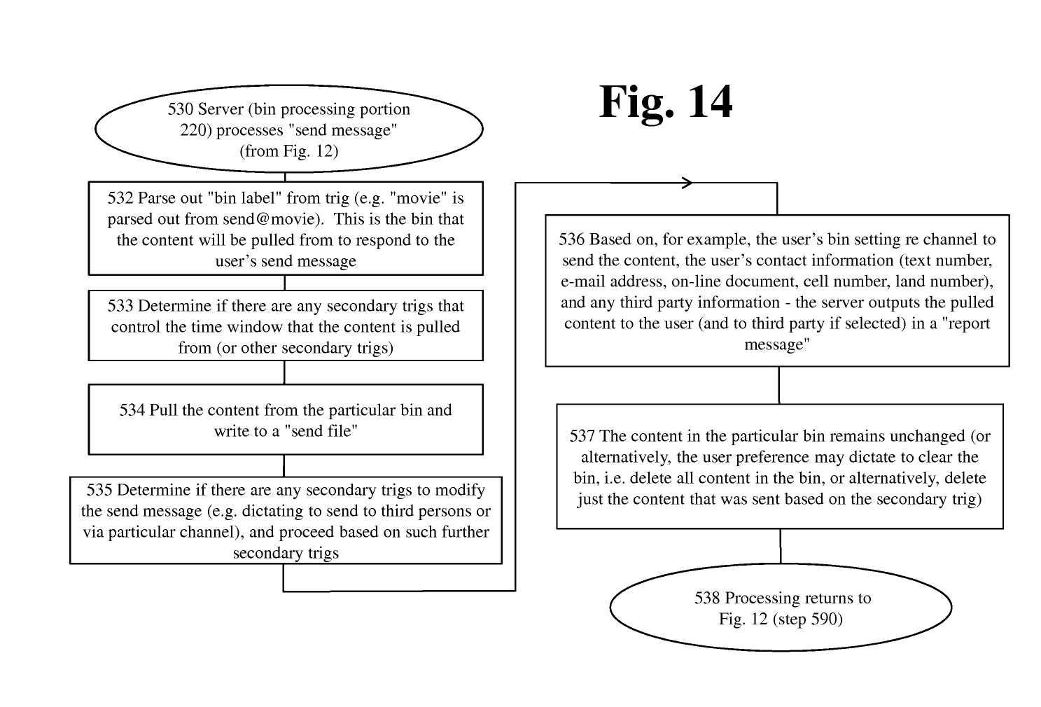

As reflected in step 530, based upon the command in the trig, the server 200 determines that the message is a “send” message. Accordingly processing passes to FIG. 14 as described below.

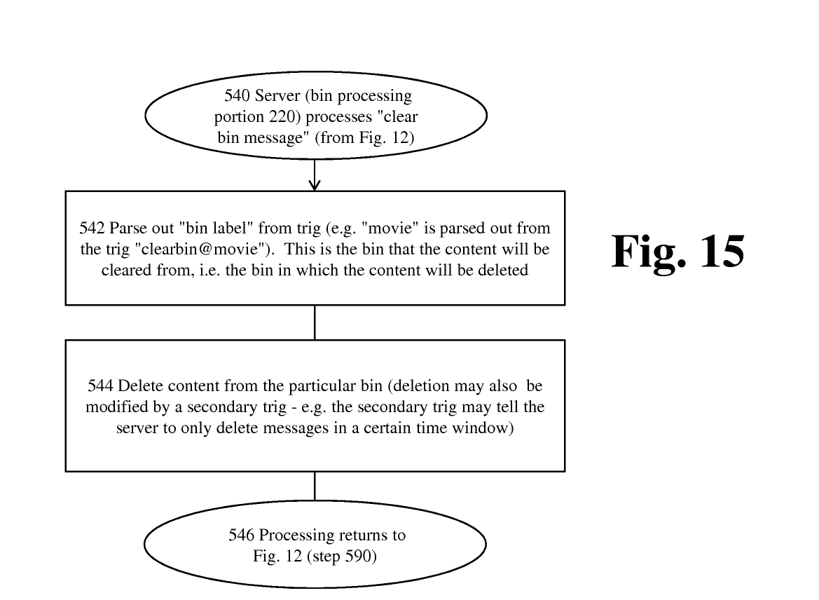

As reflected in step 540, based upon the command in the trig, the server 200 determines that the message is a “clear bin” message. Accordingly processing passes to FIG. 15 as described below.

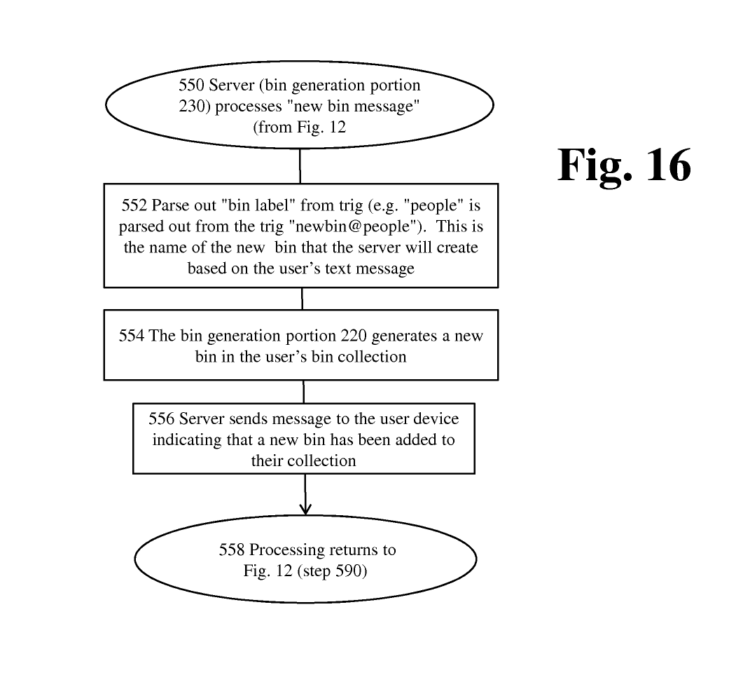

As reflected in step 550, based upon the command in the trig, the server 200 determines that the message is a “new bin” message. Accordingly processing passes to FIG. 16 as described below.

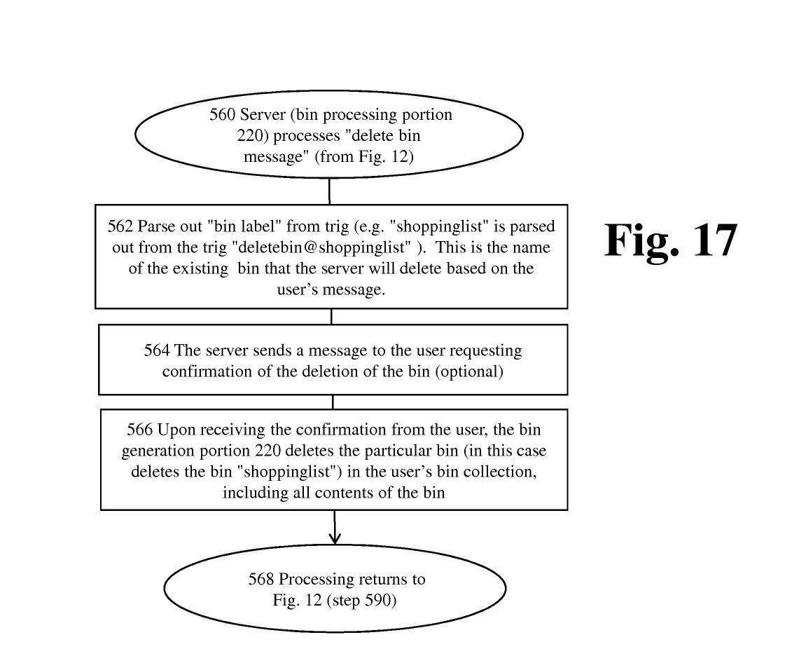

As reflected in step 560, based upon the command in the trig, the server 200 determines that the message is a “delete bin” message. Accordingly processing passes to FIG. 17 as described below.

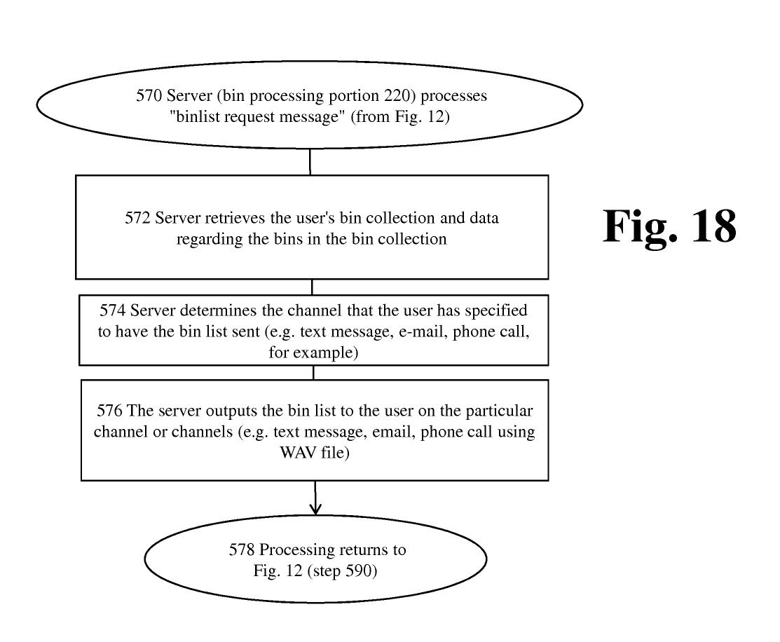

As reflected in step 570, based upon the command in the trig, the server 200 determines that the message is a “bin list” message. Accordingly processing passes to FIG. 18 as described below.

As shown in FIG. 12, after any of steps 520, 530, 540, 550, 560, or 570, the processing passes to step 590. In step 590, processing of the message from the user is complete. As a result, processing returns to step 596 of FIG. 11.

FIG. 13 is a flow chart showing in further detail the server (i.e. the bin processing portion 210) processes “add message” (step 520 of FIG. 12) in accordance with one embodiment of the invention. As shown, the process starts in step 520 and passes to step 522. In step 522, the server attempts to identify a bin label from the trig based on an exact match. For example, from the trig “add@movie”, the server attempts to find a bin named “movie” in the bin collection of the user. Then, the process passes to step 523. In step 523, the server determines whether identification of a bin in the user's bin collection vis-à-vis the bin label in the trig (from the user) was successful based on an exact match. If yes, then the process passes directly to step 525.

On the other hand, if no in step 523, then the process passes to step 524. In step 524, the server performs fuzzy logic processing on the “bin label” that was included in the trig. The processing passes to step 525 upon the fuzzy logic successfully determining a bin to which the content will be written.

If fuzzy logic is unsuccessful in step 524, then the server may write the content in the text message to a catchall bin in the user's bin collection. The process then passes to step 528.

In step 525 of FIG. 13, the server writes all the content in the message, which was received from the user, to the identified bin. In this example, the content is written to the user's movie bin. In conjunction with writing the content to the particular bin in the user's bin collection, the server may write (or otherwise associate) date, time and/or other information with the “bin-content item” (in the bin) resulting from the user's text message.

After step 525, the processing passes to step 528. In step 528, the processing returns to FIG. 12 in step 590.

As reflected in FIG. 13, multiple users may respectively add content to a bin in the user's bin collection. Also, multiple users may respectively pull content from a particular bin in the user's bin collection. Various other manipulation of content in a bin collection may be respectively performed by a single user or other users. Such respective access to a particular bin collection by multiple users are described further below.

FIG. 14 is a flow chart showing in further detail the server (the bin processing portion 210) processes “send message” (step 530 of FIG. 12) in accordance with one embodiment of the invention.

As shown in FIG. 14, the process starts in step 530 and passes to step 532. In step 532, the server parses out the bin label from the trig in the user's text message. For example, the bin label “movie” is parsed out from the trig “send@movie”. After step 532, the process passes to step 533. In step 533, the server determines if (in the text message) there is a secondary trig to control a “time window” that the content of the particular bin is pulled from in satisfying the user request. It is appreciated that there may be other types of secondary trigs that otherwise control the particular content that is pulled from the specified user's bin collection. After step 533, the process passes to step 534.

In step 534, the server performs the processing to pull the desired content from the particular bin. In accordance with one embodiment of the invention, the server writes that content to a “send file.” Then, step 535, the server determines if there are secondary trigs to modify the send message. For example, a secondary trig might dictate that the content should be sent to third persons and/or sent via a particular communication channel. The server proceeds with outputting the content based on any such further secondary trigs. After step 535, the process passes to step 536.

In step 536, based on the user's bin settings, processing particulars and/or other parameters, the server 200 outputs the content to the user and/or third person in a report message. For example, the user's bin settings may dictate the user's contact information to which the content is sent (text number, e-mail address, on-line document, cell number, land number, for example), and any third party information. Such third party information may dictate the particular third-party to which the content should be sent given the particular situation, as well as the particular communication channel that should be utilized. A user's bin settings may be represented in the processing particulars 1032 of FIG. 10, in accordance with one embodiment of the invention.

After step 536 of FIG. 14, the process passes to step 527. Step 537 reflects that the content in the particular bin, from which the content was hold, remains unchanged. Alternatively, user preference may dictate to clear the bin, i.e., to delete all content in the bin. Further alternatively, the server may simply delete the content that was sent in the report message. For example, if a secondary trig dictated a particular time window to limit the content that was sent in the report message, then only that content might be deleted from the particular bin.

After step 537, the process passes to step 538. In step 538, the processing returns to FIG. 12 and step 590.

FIG. 15 is a flow chart showing in further detail the server (the bin processing portion 210) processes “clear bin message” (step 540 of FIG. 12) in accordance with one embodiment of the invention.

As shown, the process of FIG. 15 starts in step 540 and passes to step 542. In step 542, the server parses out the bin label from the trig. For example, the server parses out the bin label “movie” from the trig “clearbin@movie”.

Such parsed out bin label dictates the particular bin that content will be cleared from, i.e., the bin in which the content will be deleted. After step 542, the process passes to step 544. In step 544, the server proceeds with the deletion processing. Specifically, the server deletes the content, including each bin-content item, from the particular bin. It is appreciated that a secondary trig from the user may be utilized to control deletion of content in the user's bin. For example, a secondary trig, included with the delete message from the user, may dictate that only content in a particular time window is to be deleted. Further secondary trigs may be utilized to control other aspects of deletion, as desired. After step 544, the process passes to step 546. In step 546, the processing returns to FIG. 12 and step 590.

FIG. 16 is a flow chart showing in further detail the server (the bin generation portion 230) processes “new bin message” (step 550 of FIG. 12) in accordance with one embodiment of the invention.

The processing the FIG. 16 starts in step 550 and passes to step 552. In step 552, the server parses out the bin label from the trig. For example, the bin label “people” is parsed out from the trig “newbin@people”. Such is the name of the new bin that the server will create based on the user's text message. After step 552, the processes passes to step 554.

In step 54, the server, and in particular the bin processing portion 220 generates a new bin in the user's bin collection. After step 554, the process passes to step 556. In step 556, the server sends a message to the user indicating that the new bin has been added to the user's bin collection. Then, the process passes to step 558. In step 558, processing returns to FIG. 12 and step 590.

FIG. 17 is a flow chart showing in further detail the server (the bin processing portion 210) processes “delete bin message” (step 560 of FIG. 12) in accordance with one embodiment of the invention.

As shown, the process starts in step 560 and passes to step 562. In step 562, the server parses out the bin label from the trig. For example, “shoppinglist” is parsed out from the trig “deletebin@shoppinglist”. This is the name of the existing bin that the server will delete based on the user's message. Accordingly, it is appreciated that the processing of FIG. 17 deletes the bin itself as well as all content in that bin. In contrast, the processing of FIG. 15, as described above, merely deletes content in the particular specified bin, and does not delete the bin itself.

After step 562 of FIG. 17, the process passes to step 564.

In step 564, the server sends a text message to the user device requesting confirmation of the deletion of the bin. It is appreciated that such confirmation text message (to the user) may be optional. However, given the potential adverse consequences of inadvertent deletion of a bin, confirmation of such deletion may be preferable.

After step 564, the process passes to step 566. In step 566, upon receiving the confirmation from the user, deletion of the bin is initiated. Specifically, in accordance with one embodiment of the invention, the bin processing portion 220 deletes the specified bin in the user's bin collection. In accordance with one embodiment of the invention, all content in such deleted bin is also deleted. However, it is appreciated that content in a deleted bin might be preserved some manner. Also, functionality may be provided to retrieve a deleted bin including content in that bin. For example, a user may be provided the ability to retrieve a deleted bin with content for a particular time period, e.g. within 24 hours.

After step 566 of FIG. 17, the process passes to step 568. In step 568, processing returns to FIG. 12 and step 590.

FIG. 18 is a flow chart showing in further detail the server (the bin processing portion 210) processes “add message” (step 570 of FIG. 12) in accordance with one embodiment of the invention.

Accordingly, the processing of FIG. 18 may be desired in the situation that the user forgets the name of the bins in her bin collection. In such situation, the user may request a list of her bins, i.e. a bin list. As shown, the processing of FIG. 18 starts in step 570 and passes to step 572. In step 572, the server retrieves the user's bin collection and data regarding the bins in the bin collection. Then, in step 574, the server determines the particular channel the user has specified to have the bin list sent. For example, user preference may dictate that the bin list for the user is sent via text message, e-mail, phone call, or other communication channel, for example. In accordance with one embodiment of the invention, a user might request that the bin list be sent to the user via e-mail, i.e. with the intent of upon receiving the e-mail from the server 200, the user might copy and paste the bin list into her OUTLOOK contacts, and specifically into her At-It contact, for example. After step 574, the processing passes to step 576.

In step 576, the server proceeds and outputs the bin list to the user on the particular channel or channels (e.g. text message, email, phone call) as requested based on user preference. Output from or input to the server 200 via phone call may use Waveform Audio File Format (WAV) in accordance with embodiments of the invention.

After step 576, the processing of FIG. 18 passes to step 578. In step 578, the processing returns to FIG. 12 (step 590). Further processing is thereafter performed as described above.

FIG. 19 is a user interface, as displayed on a smartphone for example, showing aspects of control messages in accordance with one embodiment of the invention. As described above in reference to FIG. 5, the messages used in processing by the At-It server 200 may include a server control message (sent from the server) and a user control message (sent from the user). Such messages may not include a trig.

In accordance with one embodiment of the invention, a server control message may be sent when established protocol of messages is not satisfied. For example, if the user sends the server a message “add@mi”, and given the bins listed in FIG. 19, then neither fuzzy logic nor default settings may be able to identify what the user intended and/or interpret what action should be taken upon the message. In such situation, the At-It server 200 might simply add the message to the user's catchall bin. Alternatively, the At-It server 200 attempts to reach out to the user to clarify the user's intent, i.e. the At-It server 200 reaches out in the form of a control message. The user may then respond with a user control message, which addresses the question posed by the server control message. In the example of FIG. 19, the user responded with the text message “movie”, i.e. indicating that was the bin he intended In accordance with one embodiment of the invention, if no response is heard (in response to a server control message), then the message might be sent to the catchall bin after some time period, e.g. 5 minutes. Also, in one embodiment, a user can opt not to get corrective messages, i.e. not to get a server control message, and have the message go directly to the “catchall” bin. Various other default processing may be performed, as desired.

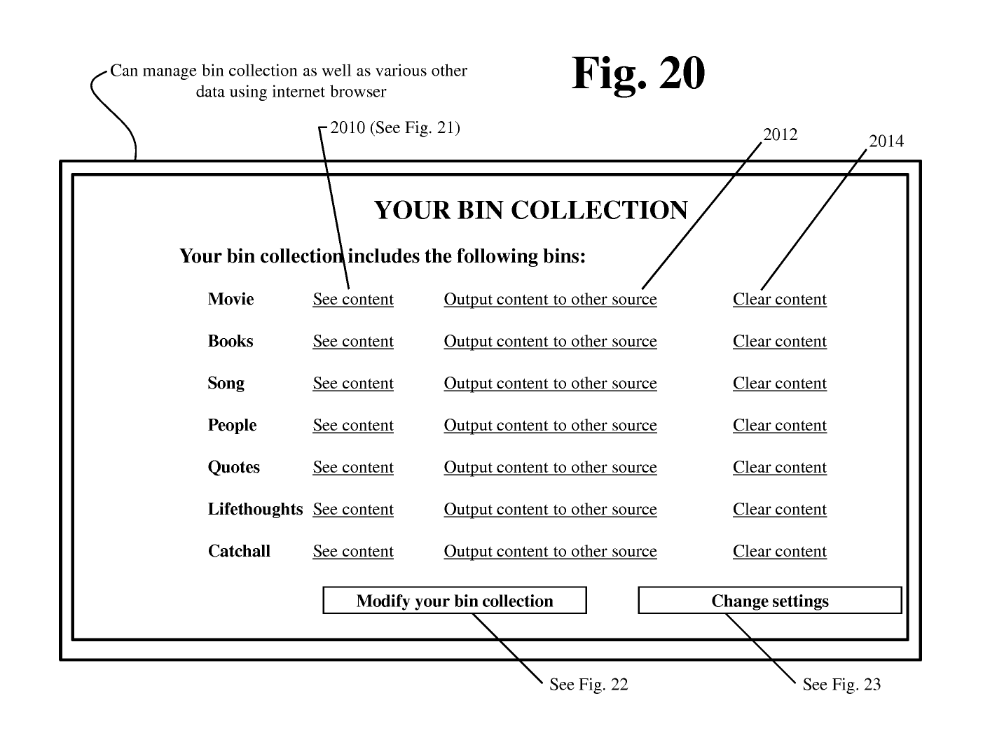

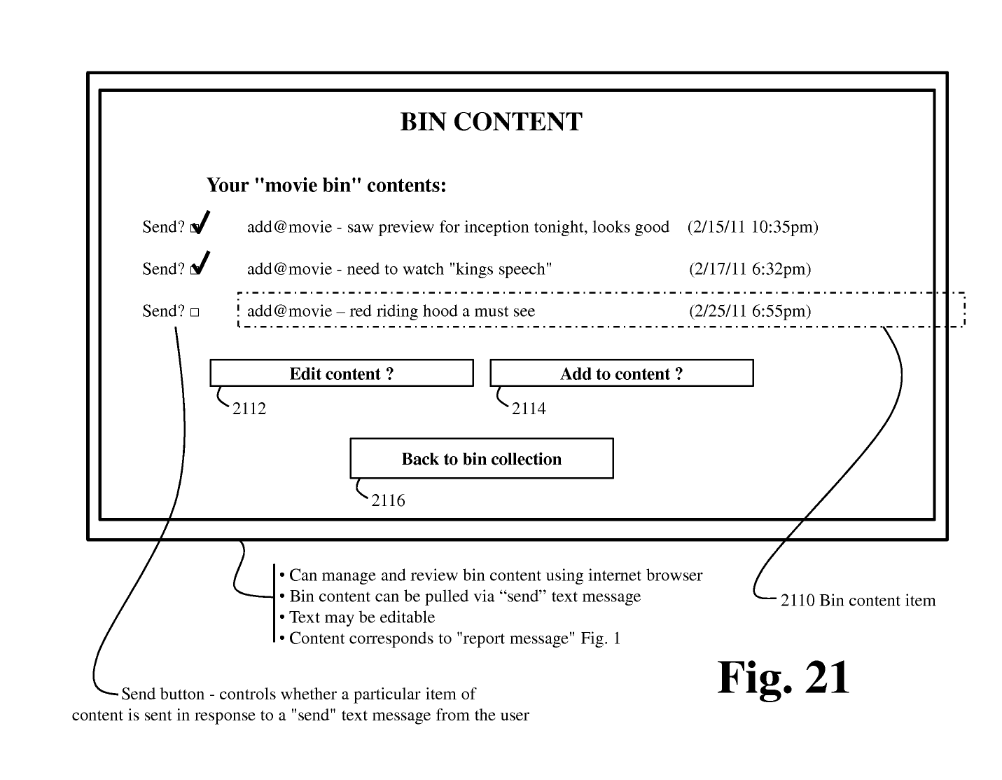

FIG. 20 is an illustrative graphical user interface (GUI) showing a user's bin collection and related functionality in accordance with one embodiment of the invention. That is, the GUI of FIG. 20 (as well as FIGS. 21-25) may be presented on the user's computer in a web session with the At-It server 200 or using a mobile application, i.e. a mobile app, on the user's smartphone. The web session might be conducted using INTERNET EXPLORER over the Internet, or using some other browser application or some other network, for example.

FIG. 20 lists the user's bin collection including all the user's bins. In this example, the user's bin collection includes the bins: movie, books, song, people, quotes, lifethoughts, and catchall As shown, the user can view the content in a particular bin by clicking the link 2010 (see FIG. 21). The user can output the content to a particular source (such as a particular text number, e-mail address, cell phone, land phone, or online document, for example) by clicking the link 2012. For example, the content might be output to a GOOGLE DOC document and shared with friends using such document, or otherwise shared. In accordance with one embodiment of the invention, the user may specify that upon the At-It server 200 receiving a send message, the At-It server 200 sends the content of a particular bin to other third persons, e.g. friends, using a communication channel (text message, e-mail, phone, for example) as desired. Accordingly, it is appreciated that various rules may be utilized to control the sending/sharing of content disposed in the user's bin collection, and such may be disposed in the processing particulars 1032 in the user's account, for example. Further, the user can clear the content in a particular bin by clicking the link 2014, as shown in FIG. 20. The link 2014 does not delete the bin itself, but merely clears/deletes the content in the bin

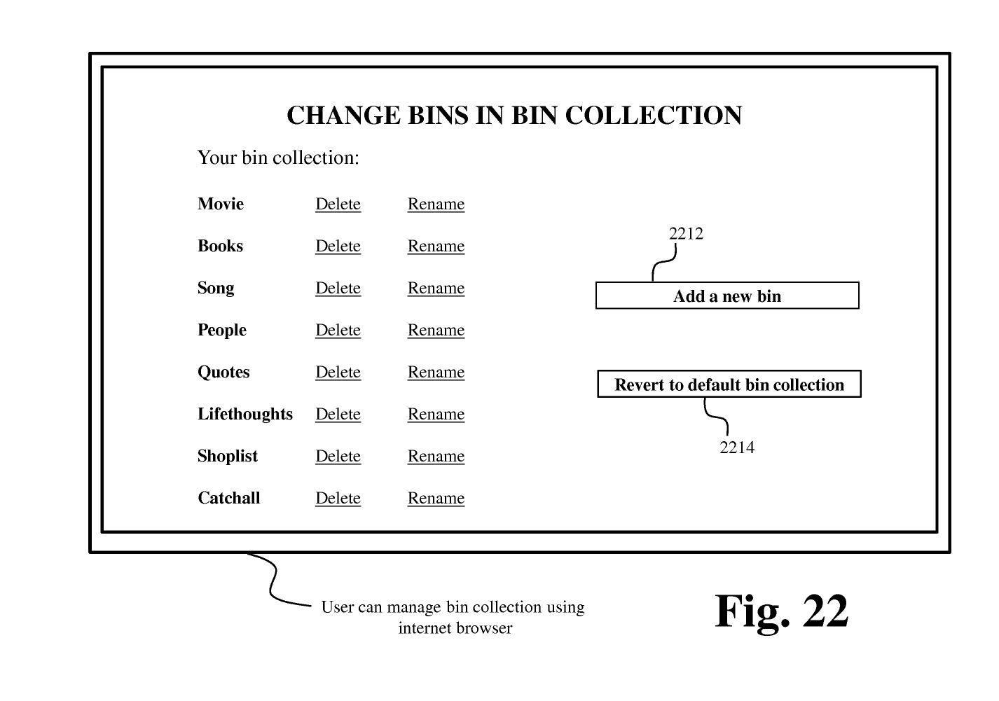

Accordingly, the functionality provided in FIG. 20, and in FIGS. 21-22, provide some functionality as that provided by the messages and trigs of FIG. 4, described above. It is appreciated that various bin manipulation functionality described herein as performed via webpage (or via suitable mobile application on a user device) might also be performed using a suitable command via text message from the user It is also appreciated that various bin manipulation functionality described herein as performed using a suitable command via text message from the user might also be performed via webpage (or via suitable mobile application on the user device). In accordance with further embodiments of the invention, it is appreciated that further icons may be presented to the user, i.e. such that the user may select such icons for desired processing.

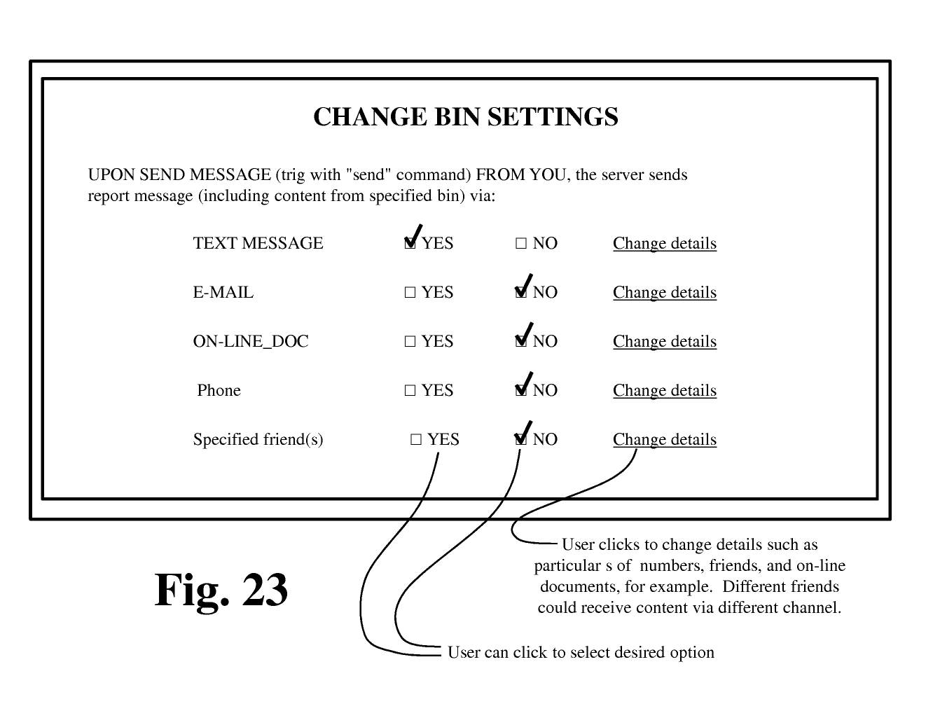

FIG. 20 also provides the user the option to modify her bin collection in the web session (see FIG. 22), as well as to change settings in her bin collection (see FIG. 23).

FIG. 21 is an illustrative GUI showing the content of a user's “movie bin” and related functionality in accordance with one embodiment of the invention. The content shown in FIG. 21 corresponds substantially to the report message as shown in FIG. 1. A user might opt to bring her bin content up via a web browser (or mobile application) due to large amounts of content or the desire to copy and paste content into another document, such as into a MICROSOFT WORD document, for example. In accordance with one embodiment of the invention, the content of the particular bin may be presented to the user in a manner similar to the way in which e-mails are presented. For example, each text message that was added to the particular bin of the user may be presented as a respective “bin content item” 2110. The server 200 may associate various attributes to each item, such as time the text message content was received and other parameters. Further, in a manner similar to e-mail presentation, the server 200 might provide desired functionality that may be applied to each item, such as the ability to delete an item or to forward an item to a further person. As shown in FIG. 21, the button 2112 allows the user to activate the bin content so as to be editable. The button 2114 allows the user to add content to the bin. Bin content in the bin collection that has been changed may be so indicated by suitable indicia. The button 2116 may be selected by the user so as to negotiate back to the user's bin collection, i.e. back to the GUI of FIG. 20.

It is appreciated that date and time information that is associated with particular content being added to a user's bin, for example, or any other date and time information, or any other attributes in general may be tracked, documented, presented, output, and/or otherwise manipulated, as desired.

FIG. 22 is an illustrative GUI showing functionality related to changing bins in the user's bin collection in accordance with one embodiment of the invention. As shown, the user may delete a bin or change the name of a bin by selecting a particular link, as shown. Also, a user may add a new bin (button 2212) or revert to some default bin collection (button 2214), i.e. such as the bin collection provided by the At-It server 200 when the user first joined on to the At-It system. In accordance with one embodiment of the invention, reversion to a default bin collection may, or may not, preserve existing bin content in some predetermined manner.

FIG. 23 is an illustrative GUI showing functionality related to changing bin settings in accordance with one embodiment of the invention. In particular, FIG. 23 shows that the user may change the particular communication channel via which the server 200 outputs communications (such as report messages) in response to a “send message” from the user. As shown the server 200 might output communications via text message, e-mail, phone, on-line document, or in some other manner or communication channel. FIG. 23 shows that the user may control in a piecemeal manner the channel(s) via which a particular report message is sent. However, the particular channel via which other communications are received by or sent to the server 200 may also be controlled by the user. Further, the particular communication channel may be adjusted in some global manner. For example, the user may want content from some of her bins to be forwarded via text message and content from other bins to be forwarded via e-mail. Such functionality relating to the adjustment of the particular channels utilized my be provided via webpage, mobile application and/or via a suitable control trig, for example. In general, FIG. 23 shows that the user may control the particular communication channels utilized, the type of message that is sent, and who the message is sent to, for example. For example, different friends might receive content via different channels. Bin settings as reflected in FIG. 23 may be represented in the processing particulars 1032 of FIG. 10, for the particular user.

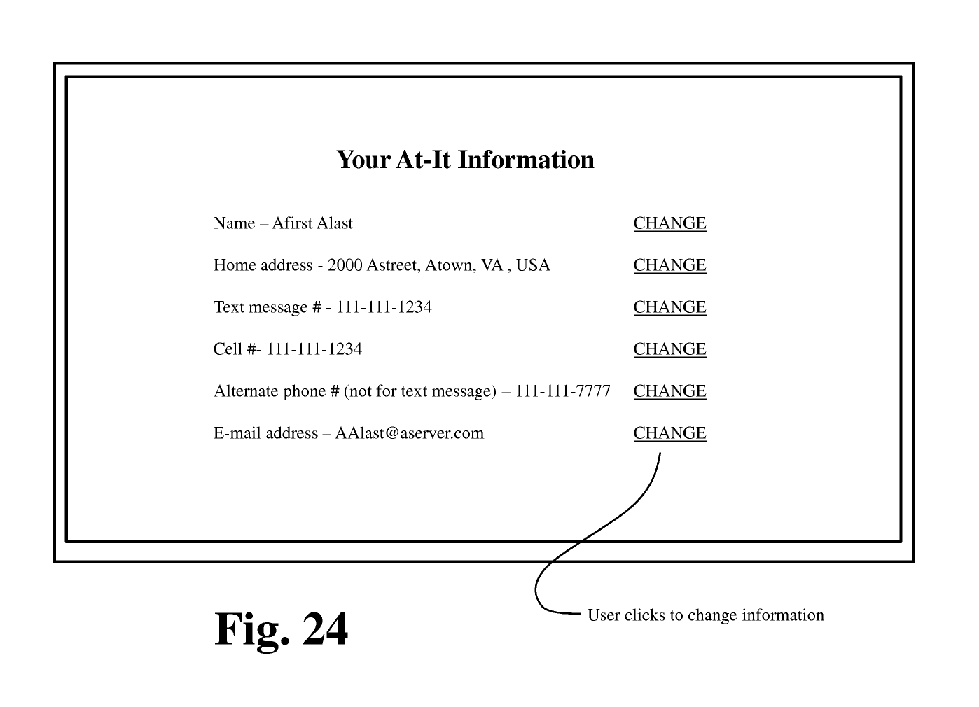

FIG. 24 is an illustrative GUI showing a user's personal information and functionality related to changing the user's personal information, in accordance with one embodiment of the invention. Accordingly, the user might change the personal information that is stored in the user's account, as such information is depicted in FIG. 10. The user's information may include name, address, text message number, and e-mail address, as well as other information needed or desired in operation of the server 200.

FIG. 25 is an illustrative GUI showing functionality related to changing the fuzzy logic, which is utilized by the At-It server 200, in processing a user's message in accordance with one embodiment of the invention. As described herein, “fuzzy logic” is utilized to deal with imprecise data from the user and provides processing, that is performed by the At-It server 200, to determine membership including an association, such as an association of a bin label to a bin name, based on a matter of degree rather than a yes-no situation. As an example, an option may be provided to the user that if the first, second, and so forth letter of the bin label (in a text message received by the At-It server 200) matches a bin name, then the At-It server 200 should go ahead and include that text message in that bin. Thus, for example, if the trig in a text message from the user was “add@m” and no other bin started with the letter “m”, then the At-It server 200 would place the text (of the text message) in the “movie” bin. As described above, a user may come to use and rely on the fuzzy logic as a quicker way to craft trigs and send texts to the At-It server 200.

Fuzzy logic is not limited to use in conjunction with bin names. For example, fuzzy logic might also be used in conjunction with “commands” in a trig, or in conjunction with other character strings, i.e. text strings, used in the invention, for example.

In general, fuzzy logic may be used in the comparison processing of the invention to handle imprecise data. In particular, fuzzy logic may be used to associate a first item (e.g. a bin label) to a second item (a bin in the bin collection of a user, as electronically stored in the server 200) even though there is not a precise match. Accordingly the bin label “mv” in a trig from the user may be associated with the bin “movies” even though there is not a precise match. For example, a search and compare algorithm may be used that identifies a particular bin. Further details are described below with reference to FIG. 32.

Other aspects of fuzzy logic processing are shown in FIG. 25. For example, the At-It server 200 might perform a comparison based on overall similarity of bin label with user's bins, to determine which bin is most similar and assign the content to that bin. Further, the At-It server 200 might give numbers in the trig priority over letters, or alternatively letters priority over numbers. As shown by the GUI of FIG. 25, the user may select which of these fuzzy logic approaches the user wishes to utilize by checking a box. Relatedly, the user may select whether, when fuzzy logic is used, she wishes to have confirmation of the placement of a message into a bin. Other aspects of fuzzy logic processing may be used in the invention.

As shown in FIG. 25, a further feature is a bar 2502, i.e. a scale of sorts to control how much fuzzy logic is used. The user can grab and move the bar (shown) with curser to adjust how much fuzzy logic is used. The position of the bar 2502 thus varies the fuzzy logic used, in some predetermined manner and may rely on the above described fuzzy logic approaches (as shown in FIG. 25) or other approaches. Accordingly, fuzzy logic attributes may be controlled by the bar 2502 of FIG. 25 (or a plurality of bars) in a manner akin to the manner in which a sound level for a particular frequency band is controlled by a respective slide control (as described in U.S. Pat. No. 6,111,755 issued Aug. 29, 2000 (application Ser. No. 09/038,729)), or in the manner of iTUNES SLIDER CALC—MORTGAGE CALCULATOR. For example, as the user moves the bar 2502 to the right, as shown in FIG. 25, more fuzzy logic features are activated in some predetermined manner. On the other hand, as the user moves the bar 2502 to the left, fewer fuzzy logic features are activated in some predetermined manner. In accordance with one embodiment of the invention, fuzzy logic may be used to address spaces in the trig. For example, the At-It server 200 may ignore spaces in a text message—in its identification of a trig in the text message. In such processing, the server 200 might look to the group of characters in front of the trick as the command, and look to the group of characters in back of the trick as the bin.

Hereinafter, various further aspects of the invention will be described.

A text message as used herein generally means a message containing characters exchanged between electronic devices, inclusive of electronic systems. A common scenario is a user sending a text message using a smartphone. For example, a user may send and receive text messages as described herein using the DROID phone by MOTOROLA and supported by VERIZON, with novelty of the invention residing in both the manner in which the user crafts the text messages (sent to the At-It server from the user) and in particular the processing performed by the At-It server in manipulation of text messages received from the user and text messages sent to the user. Text messages may be sent using Short Message Service (SMS) technology, and/or Multimedia Messaging Service (MMS) technology. In general, the text messaging as described herein may be performed using any suitable text messaging software, application, app, texting app, text messaging tool, and/or module, for example.

A text message may be provided to include various “characters” including the 26 letters of the alphabet, 10 numerals, and various symbols including characters typically set forth on a standard keyboard (such as ! @ # $ % ̂ & * ( ) + = [ ] { } | \ ; : ' “ < >, . / ? _-), for example. In general, it is appreciated that the invention may utilize letters, numbers, alphanumerics, symbols, or any other character in practice of the invention.

As used herein, a “character string” means a group of characters, i.e. a string of characters identifiable as a group of characters. Relatedly, the term “text string” and “character string” are used herein interchangeably. An example of a character string is “add@movie”.

In practice of the invention, in accordance with some embodiments, a sequence of numbers is used by the user to send a text message to the server 200, and a sequence of numbers is used by the server 200 to send text messages to the user. In its simplest sense such numbers might simply be the smartphone number of the user and a number assigned to the server 200. However, it is appreciated that rather than numbers, other characters might be used. Accordingly, the term “routing character string”, as used herein, encompasses a smartphone number of the user, but also encompasses any sequence of characters that uniquely identifies a user device, server, or other processing device in such manner that a text message (or other communication) may be forwarded thereto. Thus, the term “routing character string” reflects a more generic sense of the standard phone/text number. Accordingly, it is appreciated that any disclosure herein of use of a smartphone number, phone number, or similar disclosure may instead (of a “number”) utilize any other routing character string. In general, any suitable routing string may be used in practice of the invention as described herein.

As used herein, the terms type, key, enter, input, text in, and/or other similar terminology are used interchangeably to mean that the user enters data into the user device, e.g. such as the user keying in a text message to her phone.

A mobile application or an “app” (short for application) as used herein means software disposed on a user's device for the purpose of providing At-It related functionality and performing other related tasks for the user, as described herein. For example, an At-It app might be disposed on the user's DROID smartphone.

As described herein, phrasing such as tells, talks, dictates, conveys, advises, recognizes, instructs, and/or other similar terminology in the context of the server 200 (or any other computer processing portion), means to communicate data to the processing portion based upon which the processing portion will take certain action based on programming attributes in the processing portion. An example is a disclosure of “the user device talks to the server 200.” Accordingly, such phraseology is intended in the machine sense, and not in an oral-person talking communication sense. In similar vein, the term “know” or the server “recognizes” or similar phraseology in the context of the server 200 (or other processing portion) means that the processing portion is provided with programming attributes to act on particular data, so as to perform a particular task.

As described herein, described interaction of the user with the At-It server 200 means, for example, through the user's user device (e.g. smartphone), the user's computer via web page, the user's landline telephone, or via some other processing device or system, which interfaces with the human user and electronically communicates with the server 200—so as to provide the features described herein. Accordingly and illustratively, a description of “the server 200 sends the report message to the user device of the user” might be simply characterized by the phrase “the server 200 sends the user a report message”.

The term “processable” as used herein means that the server is able to successfully perform processing on the particular message, such as acting on a trig to obtain a desired result for the user.

As noted above, is appreciated that the systems and methods of the invention may well work with existing known user devices and network technology, as depicted in FIG. 1, for example, with novelty of the invention residing in the manner in which text messages and other communications are crafted by the user and in the server 200. Thus, the innovative processing performed by the At-It server 200 leverages existing technology. Alternatively, or in addition to, the invention may involve a mobile application, i.e. a software application, disposed on the user's tangibly disposed user device (e.g. smartphone or computer) so as to leverage the features of the invention. Indeed, in one embodiment, features of the invention might be implemented exclusively on a user's local computer in a software program. The program might handle and provide the maintenance of bins, adding content to a bin, pulling content from a bin, and deleting bins, for example. Such processing might provide a user interface of the appearance of a text messaging application, but indeed be working only locally on the user's computer. In accordance with further embodiments of the invention, such local processing may be performed in conjunction with interfacing with the At-It server 200 in some selective manner. That is, local processing and interface with the At-It server 200 may be combined.

It is appreciated that features described herein as being performed via web page may be performed via a user's personal device (such as a smartphone). In particular features described herein as being performed via web page may be performed via a mobile application (an app) on the user's smartphone or via a browser feature on the user's smartphone, for example.

Various features of the systems and methods of the invention are described herein. It is appreciated that described features may be used in conjunction with other described features so as to provide desired functionality.

In general, it is appreciated that by allowing the user to name the bins, the user may use names that are very intuitive and helpful to them. Relatedly, the user can thus craft a bin collection that is uniquely geared to her or his life.

The invention may utilize suitable backup arrangements. For example, the At-It server 200 might periodically e-mail or otherwise forward all bin content to the user. For example, all content in the user's bin collection might be sent to a document using GOOGLE DOCS, which is accessible by the user. The user may be provided the option to download all bin content to the user's PC, smartphone, or other electronic device. In accordance with one embodiment of the invention (in response to a suitable text message, phone call, or email) the server might fax all (or selected content) to a fax number provided by the user, for example.

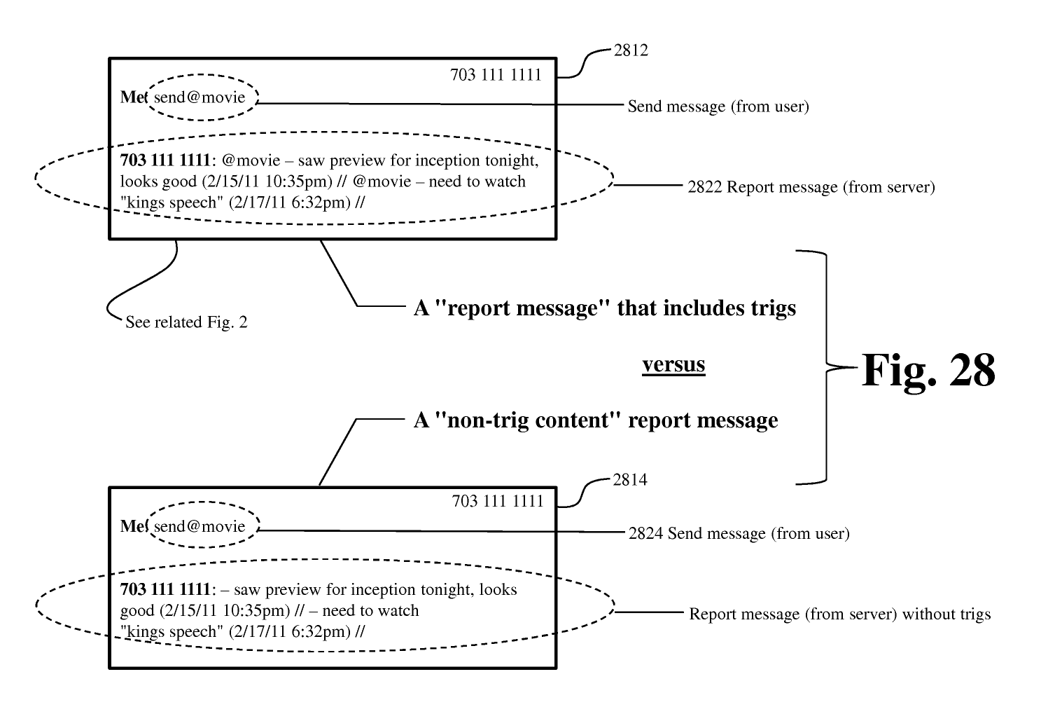

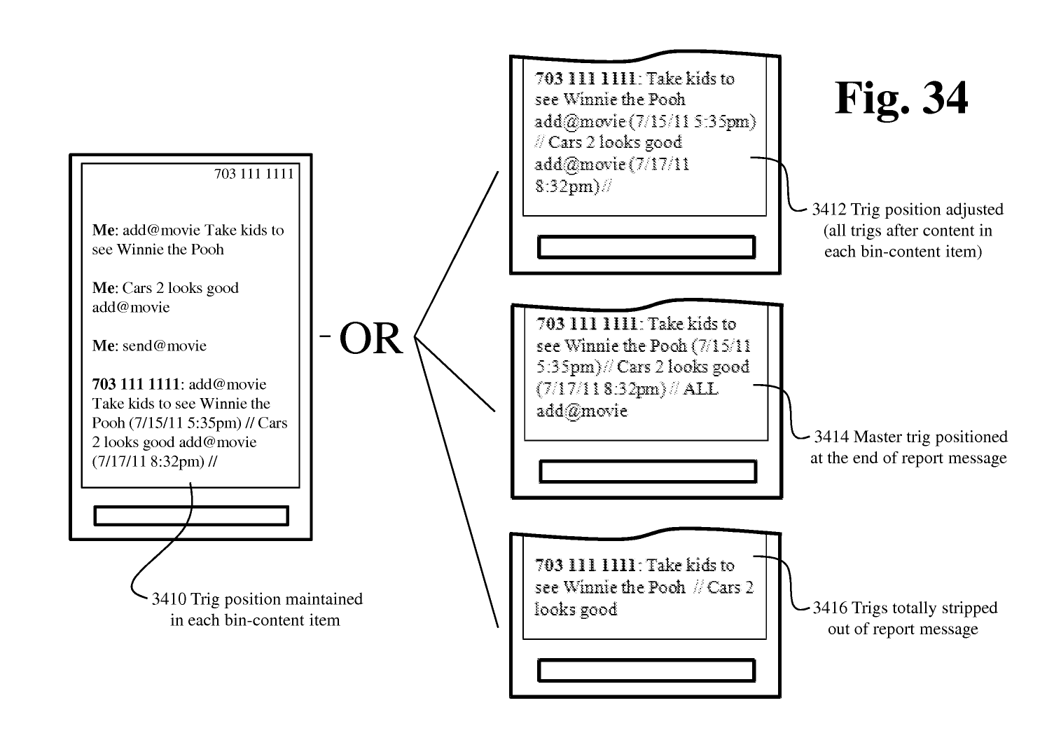

In accordance with one embodiment of the invention, as described below, the trigs in messages may be stripped out of the content and/or the content might be otherwise modified for presentment to the user or otherwise. For example, content from the movie bin might be presented without the particular trigs add@movie, but rather under a collective header indicating that all such messages possessed such trig. However, it may be desirable to retain the content “as is.” Further details are described below with reference to FIG. 28 and FIG. 34.

As described further below, a user may be associated with multiple bin collections. On the other hand, a single bin collection and/or a single bin may be associated with multiple users.

In accordance with one embodiment of the invention, a trig may dictate that content is pulled from multiple bins in the user's bin collection. In the report message, suitable indicia may be provide to reflect which bin which content was pulled from.

In accordance with embodiments of the invention, it is appreciated that processing performed is not case sensitive. In other embodiments, processing may be case sensitive.

As used herein, “data” and “information” are used interchangeably.

In accordance with one embodiment of the invention, as described in detail herein, the trig and other components of a particular text message are demarcated by spaces. However, the invention is not limited to such. For example, a particular character might be used to demarcate the components of a text message—so long as the server 200 knows, i.e. is programmed, to perform processing based on such demarcation.

In accordance with embodiments of the invention, the user generating the text message using a user device, such as a smartphone, is human, i.e. a typical scenario of a person sending a text message using her phone. However, the invention is not limited to such. In particular, the text message might be generated by a computer processor in some manner, i.e. the computer processor would thus be the user.

As described herein, an “add” message and related terminology is meant in a summation sense, and not in an advertisement sense.

It is appreciated that the order of components of a trig, for example, may be adjusted. For example, the bin label might be placed before the trick and the command placed after the trick.

It is appreciated that fuzzy logic as described herein is not limited to application in conjunction with bins and bin labels. That is, fuzzy logic may be applied to other character strings so as to effect an association between text that the user has entered vis-à-vis text processable by the server 200.

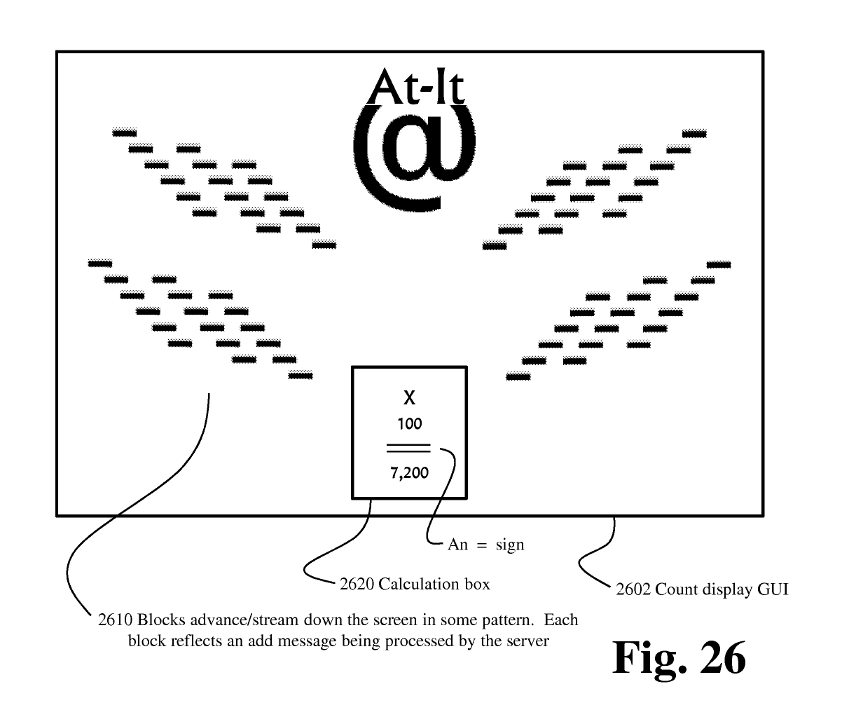

FIG. 26 is a display showing the flow of “add messages” in accordance with one embodiment of the invention. The total count of add messages and/or any other messages, may be tracked by the At-It server 200 and output as a visual representation. Each small block on the screen of FIG. 26 reflects an add message. The blocks may advance down the screen in a streaming fashion. A multiplier may be applied (100 as shown in FIG. 26). Accordingly, the representation shown in FIG. 26 reflects the processing of 7,200 add messages. The display can also include system related indicia in accordance with embodiments of the invention.

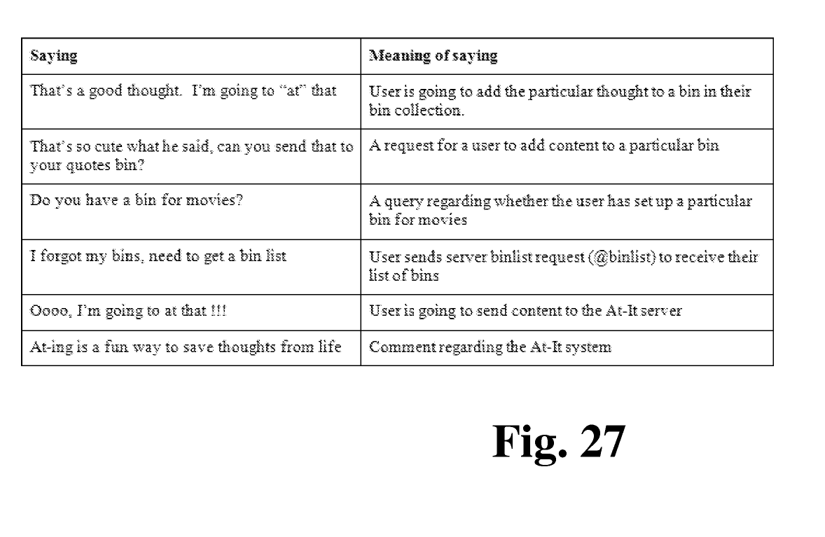

FIG. 27 is a table setting forth sayings related to the invention in accordance with one embodiment of the invention. It is appreciated that the various terminology as set forth in FIG.

27 is for purposes of explanation. It is appreciated that other terminology may be coined, in the scope of the invention, in parallel to that of FIG. 27.

Hereinafter, various further features of the invention will be described.

In accordance with one embodiment of the invention, multiple text messages may be sent by a user, received by the server 200, and processed by the server 200 in a collective manner. For example, in one embodiment, the collective processing of sequential text messages may be used to provide content that does not include trigs. The user first sends a text message to the server 200, including non-trig content (see FIG. 3) as that user wishes that content to go into a particular bin. Upon receipt of the first text message from the user, the server 200 places the first text message into a queue. Subsequent to sending the first text message, the user prepares and sends a second text message. The second text message includes a trig that controls the particular bin into which the content (i.e. the non-trig content) of the first text message is placed. Accordingly, in this embodiment of the invention, the server 200 processes two text messages collectively. In such processing, the non-trig content in the first text message may be the only content that is placed into the particular bin. Such collective processing might be performed by the server 200 upon the server 200 receiving a text message without a trig, or some other rule or user preference may be applied to trigger such collective processing. In this manner, the user would ultimately receive back the content he or she wished to remember, but not the trigs that controlled placement of the content into the particular bin.

In alternative processing, the content of both the first text message and the second text message is placed into the bin. The content may be placed together or in some segregated manner. The server 200 may respond to a “send message” (from the user at some future time requesting content from the particular bin) by only sending content from the first text message and not the second text message. Thus, the trigs might be preserved if the user wants to view the trigs at some point in time.

In further embodiments, there may be functionality to strip out the trigs from content in other manners, i.e. to not include trigs in a “report message” sent from the server 200 to the user (in response to a user's send message to the server). For example, a secondary trig might be included in a “send” message from the user to the server 200. The secondary trig tells the server that the server should only send the non-trig content and no strings of characters with an “@” in them, i.e. no trigs should be included in the “report message” from the server 200.

In a further embodiment, the server 200 may simply know not to send trigs in a report message. This might result from the user setting a preference to not send trigs or in some other manner advising the server that no trigs should be included in a report message. For example, this functionality might be in the form of a toggle switch (or button) that the user clicks on to include the trigs, or clicks off to not include the trigs.

In another embodiment, functionality may be provided (when the user is viewing the content via webpage or cell phone app, for example) to not show the trigs. For example, this functionality might also be in the form of a toggle switch (or button) that the user clicks on to show the trigs, or clicks off to not show the trigs.

Illustratively, FIG. 28 is a diagram showing the report message of FIG. 2 with trigs vis-à-vis a report message without trigs, in accordance with one embodiment of the invention. Specifically, the GUI 2812 shows a report message 2822 with trigs. The GUI 2814 shows a report message 2824 without trigs.

In a further embodiment, the server may determine whether other parameters are satisfied in order to determine whether to include trigs in a report message to the user. Illustratively, the server 200 may determine whether (1) a trig is positioned “first” in an add message AND whether the user's preferences are set to not send trigs back to the user, if the trig is first in the user's text message. As to the first parameter, the server 200 may simply determine whether the first string of characters in a user's “add message” includes an @, i.e. the trick. If both parameters are satisfied, then the server 200 outputs the report message to the user without trigs, as shown in FIG. 28 (GUI 2814). In such processing, it is envisioned that the report message may include trigs from some “add messages” (in which the trigs were not positioned first) and not include trigs from other add messages (in which the trigs were positioned first). This aspect, in and of itself, may provide desired functionality to some users. That is, the user may opt, “on the fly,” to (1) put a trig first in a text message to the server if the user does NOT want to see the trig in a resulting report message; OR (2) not put a trig first in a text message to the server if the user wants to see the trig in a resulting report message from the server. The user might opt to retain trigs in some bins, but not others, for example. The particular positioning of a trig in a text message, and what position dictates what, is choice of design as reflected in the programming of the server 200. For example, it might be the case that if the trig is first, then the trig will be retained in the text message content.

In general, it is appreciated that functionality may be desired to present the content without the trigs, i.e. to present the user with non-trig content. This would provide a cleaner document for review and to further work with, which might be desirable for some users. In accordance with one embodiment of the invention, as noted above, it is appreciated that non-trig content is characterized as any character string in a text message that does not include a trick, i.e. that does not include an @. Thus, as is reflected in FIG. 28, any dashes or any other miscellaneous characters might well be included in a non-trig content report message. This is due to the processing (by the server 200) of only stripping out character strings that include a trick, i.e. the @ or other trick.

FIG. 34 is a diagram showing further aspects of manipulation and presentation of trigs, in content displayed to the user, in accordance with one embodiment of the invention.

As described above and reflected in FIG. 13, a user may be associated with multiple bin collections. On the other hand, a single bin collection and/or a single bin may be associated with multiple users.

In the situation where a user is associated with multiple bin collections, it is appreciated that the server needs to input sufficient information such that communications from the user are processable. For example, although the user's bins are in different collections, the names of all the user's bins may be different. Accordingly, the server 200 may work off the user's phone number (used by the user in text messaging) and the particular bin name—such as in the case of an “add message” from a single user, for example. In the case where the user's bin collections have similar (or the same names), a secondary trig might be utilized to specify the particular bin collection to which the content should be added. Other parameters may be used to specify the particular bin collection and/or the particular bin to which a command should be applied.

A bin collection may also be associated with multiple user's devices, e.g. such that a husband and wife (or some other affiliated persons) might all populate bins in the bin collection. In accordance with one embodiment of the invention, there might be provided a first user, e.g. a core user, and secondary user(s). The server might be programmed to receive text messages, i.e. content, from any user device that is affiliated with the bin collection. Relatedly, a particular user's bin collection might have some bins that are accessible by other designated persons, some bins to which content may be added by other designated persons, and/or some bins from which content may be pulled by other designated persons, for example. In general the server 200 may be provided to limit functionality and limit access by persons other than the first user. In general, it is appreciated that access by particular users to particular bins or bin collections may be controlled as desired, such as by a user setting preferences of his or her bin collection, and the server working off of the respective numbers from which text messages are sent, i.e. the server allowing access based on the user's phone/text number.

One example of such multi-user processing is multiple people contributing to a shopping list. In this example, a user may have the eight bins of FIG. 22 in her bin collection. Seven of the bins are only accessible by her, the core user. However, by the preferences that she has set, the “Shoplist” bin is accessible by her roommate. Accordingly, the server 200 accepts text messages (e.g. add and send messages) from both her and her roommate to populate, i.e. add to the shoplist bin. Both users may contribute to the content of the bin throughout the week, as they think of things needed for their apartment or as they run out of an item, for example. For example, upon one of the roommates finishing off the salsa, she sends a text message to the server 200 “add@ sh Salsa”. At the end of the week when at the store, either may send a “send message” to the server 200 (e.g. send@ shoplist) so as to pull content from the shoplist bin. Accordingly, the At-It system 10 has provided a tool by which the roommates may aggregate all their thoughts over the course of a busy week (regarding items needed in their apartment), and by which either may pull that aggregated content at a desired time, i.e. when they are at the store.

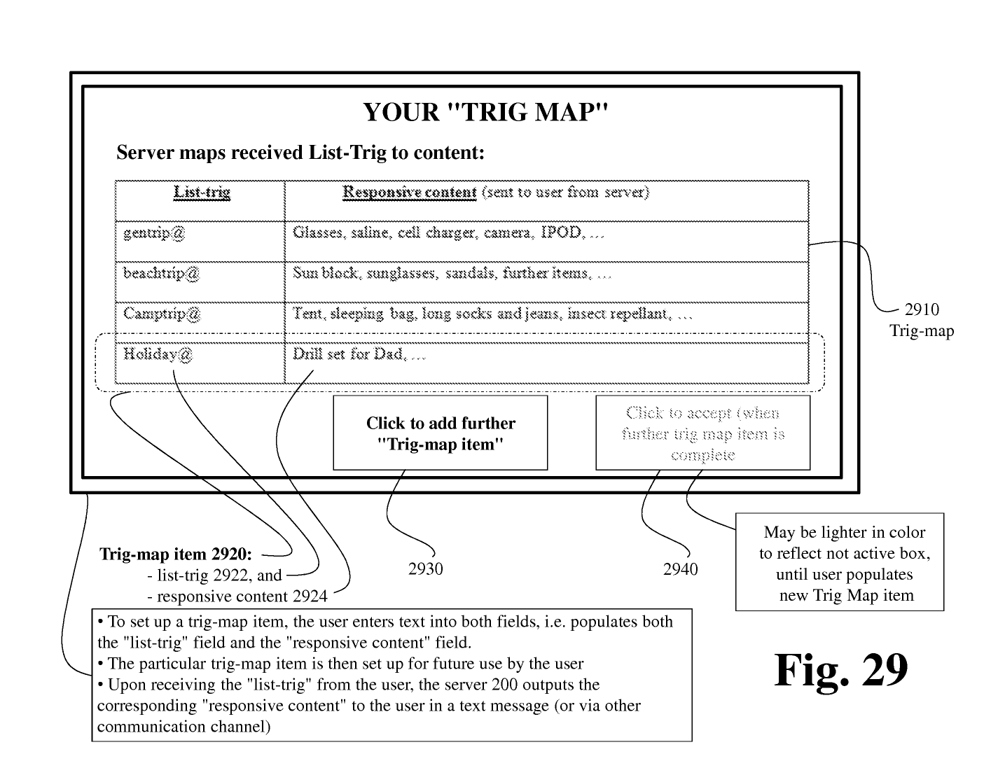

In accordance with one embodiment of the invention, the At-It system 10 provides what is herein characterized as a “trig map” feature. FIG. 29 is a user interface showing aspects of a trig map 2910 in accordance with one embodiment of the invention. The trig map allows a user to associate short strings of characters, i.e. “list-trigs,” with content. The content might be, for example, lists of items the user wishes to recall at some time in the future. One aspect of the relationship of the Trig Map feature vis-à-vis the processing described above using add messages (e.g. see FIG. 2) is that trig maps are preferably, in accordance with one embodiment, populated by the user via web page or mobile application (as shown in FIG. 29) versus populated via text message (FIG. 2). However, both are retrievable via text message or web page, for example, or otherwise. If retrieving via text message, the user does need to remember the particular list-trig she wishes to retrieve and generally what content is associated with a particular list-trig. In accordance with one embodiment of the invention, the user may send a text message of suitable format (send@triglist) to the server 200—such that the server 200 is prompted to send a list of the user's list-trigs, so as to remind the user of all his or her list trigs.

Accordingly, the trig map feature provides for a user to create a trig-map item 2920 by populating two fields that the server 200 then associates with each other. The two fields, as shown in FIG. 29, are characterized as a “list-trig” field 2922 and a “responsive content” field 2924. As noted above, the user accesses and populates both fields (i.e. populates by selecting a field and typing in text), as shown in the user interface of FIG. 29. Accordingly, trig map-items 2920 may be populated via web page as shown in FIG. 29 or via suitable mobile application, i.e. smartphone app, for example.

Accordingly, as described herein, each trig-map item 2920 (in the trig map 2910) includes both a list-trig 2922 and responsive content 2924, which corresponds to that list-trig. FIG. 29 shows a box 2930 that the user clicks to add a further trig-map item. FIG. 29 also shows a box 2940 that the user clicks to accept a further trig-map item, i.e. once the user has typed in the desired text—to populate the trig-map item. The box 2940 may be lighter in color (not active) prior to a trig-map item being properly populated by the user.

In this embodiment, each “list-trig” created by the user includes an @ and is in a particular format, so that the server 200 knows that the character string is indeed a trig, and that the server 200 needs to act on, i.e. respond to, such trig. Thus, the user is provided the ability to essentially “coin” or come up with his or her own “list-trig” names. It is appreciated that certain formats may need to be adhered to by the user. For example, the user's list-trig cannot be of a format to be indistinguishable vis-à-vis the example messages of FIG. 4, such as an add message, for example. The needed format might be imposed by the server 200 in any suitable manner, such as by checking the list-trig format upon the user populating the field, and advising the user via dialogue box if the list-trig is not of a workable/acceptable format.

In accordance with embodiments of the invention, the server is essentially blind to the particular text that is in the “list-trig” field and the “responsive content” field, other than confirming the list-trig is of an acceptable format. That is, in this aspect of the processing, all the server 200 knows is that if the server receives a list-trig 2922 from the user (via text message), then the server sends the responsive content 2924 that corresponds with such list-trig back to the user (via text message). Other communication channels may be utilized.

It is appreciated that a trig-map item may be related to one or more other trig-map items. Accordingly, multiple trig-map items might be grouped into folders or in some other way associated with each other.

Relatedly, in accordance with an embodiment of the invention, it is appreciated that bin content may also be fully editable by the user, such as via web page or app on the user's phone. For example, the user may be provided the ability to edit (or add to) bin content as shown in FIG. 21. The server 200 might reflect changes or additions to bin content in some suitable manner. For example, the server 200 might generate an “edited” indicia next to content that has been edited, and/or the server 200 might generate an “added” indicia next to content that has been added. Time stamp information and/or other attributes may be associated with such edited or added content as desired. Changes to a trig-map item might also be reflected with suitable indicia, if desired.

Accordingly, with both bin content (as shown in FIG. 21, for example) and trig-map item content (as shown in FIG. 29, for example), a user might copy and paste text as desired, or otherwise manipulate the text. For example, the user might copy text from a bin, paste that text into MICROSOFT WORD (so as to utilize available features to organize the text), and then paste the revised text into a trig-map item that the user has created.

As described above, content that is input to a bin of the user (in the user's bin collection) might be output to a GOOGLE DOC document and shared with friends using such document, or otherwise shared. Also described above is that the server 200 may send the content of a particular bin to other third persons, e.g. friends, using a communication channel (text message, e-mail, phone, for example) as desired.

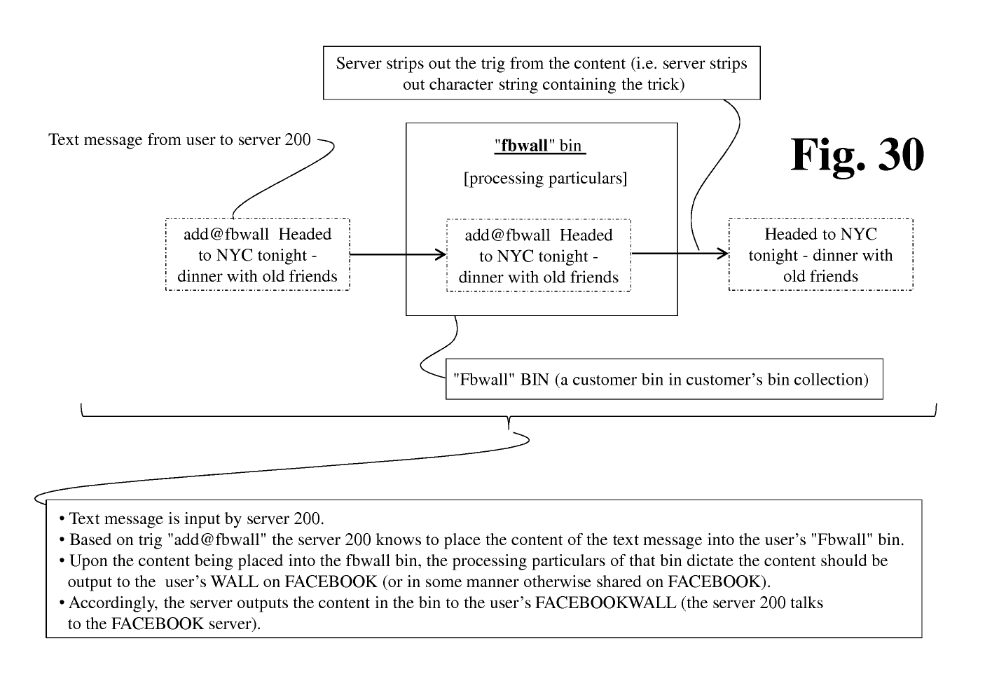

Relatedly, FIG. 30 is a diagram showing the output of content from a user's bin to a social network in accordance with one embodiment of the invention. As shown in FIG. 30, the text message is sent by the user to the server 200. The content of the text message is “add@fbwall Headed to NYC tonight—dinner with old friends”. The text message is input by the server 200. Based on the trig, the server 200 knows to place the content of the text message into the user's “fbwall” bin. Upon the content being placed into the user's fbwall bin, i.e. a queue of sorts, processing is initiated to retrieve the processing particulars associated with that bin (see also FIG. 10 above regarding processing particulars). Accordingly, the processing particulars of the bin are retrieved by the server 200. Such processing particulars, in this example, dictate that content added to the “fbwall” bin should be output to the user's WALL on FACEBOOK. Accordingly, the server outputs the content to the user's FACEBOOK WALL in a predetermined manner. This might be performed by the server 200 “talking” to the Facebook server or in some other manner interfacing with the FACEBOOK server so as to transmit the content, i.e. the non-trig content, from the fbwall bin of the user to the user's FACEBOOK WALL. As reflected in FIG. 30, in accordance with embodiments of the invention, the server 200 may strip out the trig from the content, which was placed into the fbwall bin, prior to that content being output to FACEBOOK. Accordingly, the message that is transmitted from the server 200 to FACEBOOK in this example is “Headed to NYC tonight—dinner with old friends”. The invention thus provides the capability for a user to send a text message using her smartphone, for example, to the server 200—so as to post that content onto her FACEBOOK WALL.

In accordance with embodiments of the invention, it is appreciated that the processing of the add@fbwall message may be performed using alternative processing, i.e. other than placing the content into the fbwall bin, for example. Indeed, the content need not even be placed into a bin. Rather, in accordance with one embodiment of the invention, the server simply knows from the “fbwall” bin label (in the text message from the user) that the server 200 is to forward the content onto the FACEBOOK server.

It is of course appreciated that the invention is not limited to output to FACEBOOK. Rather, using the processing of FIG. 30, content from a particular user bin may be output to some other social network or, in general, output to some other processing system or database, for example.

As described above, the processing particulars associated with a particular bin dictates that the server 200 strips the trig out of content, which is added to the particular bin, and transmits the non-trig content to FACEBOOK, for posting on the user's FACEBOOK WALL. In other embodiments, it is appreciated that the processing particulars of a particular bin might instead dictate other processing. For example, the processing particulars might dictate the content added to a bin is to be sent to a specified e-mail address, a phone call effected, a text message sent so as to control a device or system, or other communication sent via some other communication channel for example.

In accordance with embodiments of the invention, it is appreciated that the bin collection of the user may be more complex than a single layer architecture, as reflected in the bin collection of FIG. 10, for example. That is, it is envisioned that a bin collection of a user may include sub-bins, folders, or in some other manner be arranged in a grouped or hierarchical manner. For example, the quotes bin of FIG. 10 may be associated with sub-bins for various people. Manipulation, such as adding content to a sub-bin or retrieving content from a sub-bin may be performed using trigs that are uniquely associated with such sub-bin. Alternatively, manipulation of a sub-bin by the user might be performed using a first trig directed to the highest level bin and a secondary trig to control placement in a particular sub-bin positioned below that highest level bin, for example. Accordingly, each sub-bin might be associated with a respective secondary trig so as to control placement of content into such sub-bin.

In accordance with one embodiment of the invention, a bin collection may include a general trip bin that includes items to remember for all trips, such as glasses, phone charger and other general items, for example. Such general bin might be used in conjunction, i.e. grouped with, more specialized bins of the user, such as beach bin, ski trip bin, and hiking bin, for example—each of which includes listing of more specialized items to remember for the particular type of trip. Over time, the user may add items to both types of bins using a suitable trig. In planning for a trip, the user may send a suitable “send message” to the server to pull both the general bin and one of the specialized bins. The report message from the server 200 aggregates the two bins, i.e. combines the content from the two bins. Accordingly, the user is presented with a useful list to help her or him remember needed items in the upcoming trip.

In accordance with one embodiment of the invention as described herein, in conjunction with a send message from the user, the user can specify that she only wants content from a particular time window, such as between certain dates, for example. It is also appreciated that other mechanisms may be provided to control the particular content from a bin that is forwarded back to the user from the server 200, i.e. upon receiving a “send” message from the user. For example, as shown in FIG. 21, each item of content in the user's bin might be associated with a “send” button. The send button may be selectable by the user to toggle back and forth between sending such item of content in response to a send text message (from the user to the server) vis-à-vis not sending such item of content in response to a send text message. Accordingly, via webpage or app, for example, the user is provided the ability to go through all the items of content in a particular bin and choose what content the user would like sent in response to a “send” message (from the user) sometime in the future.

In accordance with one embodiment of the invention, server 200 may be programmed to automatically create a bin in response to an “add” message being received from the user. For example, the server might receive a text message from the user with the content: add@book Lord of the Rings, TOLKIEN. In this example, the user does not have a “book” bin. The server recognizes the text message as an add message and also knows that the content with trig does not associate with any existing bin of the user. Upon such determination, the server 200 creates a new bin: book. In accordance with a further variation of this feature, a secondary trig might be utilized (that is included in the text message from the user to the server). The secondary trig tells the server 200 that a new bin should be created—and tells the server that the content (in the text message) is to be added to that newly created bin. For example, the secondary trig might be: @new. As otherwise described herein, it is appreciated that various commands may be included in text messages from the user to the server 200, so as to perform desired processing.

In accordance with one embodiment of the invention, the bins in a bin collection of a user and/or the data in those bins might be manipulated in tranches, i.e. in some collective manner. For example, the user, via user preference in the server 200, might dictate that he wants the server to send report messages from some bins via text message. However, with other bins, the server 200 is dictated to send report messages via e-mail. In general, it is appreciated that user preferences may be provided to dictate processing in some collective manner.

As described above, in accordance with one embodiment of the invention, the server may retain an identity of a bin that is static. That static identity may be mapped to a corresponding bin name, which is presented to the user (and by which the user knows the bin). FIG. 31 is a diagram showing aspects of creation of a new bin and file structure in accordance with one embodiment of the invention. As shown, the server 200 Server inputs a text message from the user with the character string “newbin@books” as a trig. Accordingly, the server generates a new bin named “books”.

Illustratively, UB3116 (meaning UserBin 3116) is the file name the server associates with, i.e. maps to, the newly created bin named “books”. If the user opts to change the name of the bin (at some later time), the file name UB3116 is retained, but is merely mapped to the new name chosen by the user.

It is appreciated that “commands” as used in a trig may be structured in a similar manner. Accordingly, in accordance with one embodiment of the invention, a user may change a “command” name. Such might be desirable if another command name might be more intuitive to the particular user.

In accordance with some embodiments of the invention, the server 200 may not allow trigs names or existing bin names to be changed. However, the server might allow a user to copy a bin (including the contents thereof) and name such newly created bin as desired.

As described otherwise herein, known relational database techniques may be utilized in the invention.

FIG. 32 is a flow chart showing fuzzy logic related processing in accordance with one embodiment of the invention. As shown in FIG. 32, the process starts in step 3210 in which the server 200 initiates fuzzy logic processing on a user's text message with the content “add@bo Tale of Two Cities”. Accordingly, in this example, the user is knowingly utilizing fuzzy logic processing in only including, in her texted trig, the first two letters of one of her bins. FIG. 32 shows processing related to FIG. 13 (step 524) and FIG. 25.

After starting in step 3210 of FIG. 32, the process passes to step 3211.

In step 3211, the server retrieves the first letter in the bin label (from the trig), and assigns that letter to a variable “current label letter (CLL).” The server also retrieves the first letter from the first bin (in the user's bin collection) and assigns that letter to a variable “current bin letter (CBL).” Then, the process passes to step 3212.

In step 3212, the server compares the CLL vis-à-vis the CBL to determine if the two variables match. If there is a match, then such match indicates that such bin (in the user's bin collection) is a possible candidate to satisfy the user's “add” request. Accordingly, the processing passes to step 3213 in which the server stores the bin (corresponding to the CBL) as a “possible bin to add the content” (PBAC). After step 3213, the process passes to step 3214.

On the other hand, if no in step 3212, i.e. there was not a match, the processing passes directly to step 3214.

In step 3214, the server determines whether there are more bins that are possible PBACs. In the first pass of the processing through all the user's bins (i.e. with the first letter of the bin label vis-à-vis bin name) all the bins will initially be considered to be PBACs. After comparing the first letter in the bin label (in the trig) vis-à-vis the first letter in each of the bin names, only matches are retained as PBACs.

Accordingly, returning to step 3214, if “yes” in step 3214, then the processing passes to step 3216.

In step 3216, the server retrieves (for each bin still under consideration) the current letter (under consideration) from the next bin (in the user's bin collection), and assigns as the current bin letter (CBL) variable. In the example of FIG. 32, in the first processing of step 3216, the server would retrieve the letter “p” from the people bin. Then, the processing passes back to step 3212, as reflected in FIG. 32.

Accordingly, as shown in FIG. 32, step 3216 reflects a processing step to advance through the bins in the bin collection to compare the CLL (from the bin label of the trig) vis-à-vis the corresponding letter from each bin. Thus, step 3216 reflects that the server will first take the “b” (from the trig) in the example of FIG. 32, and compare that “b” with the first letter of each of the bins (in the user's bin collection), i.e. iteratively performing steps 3216, 3212, 3213 (if match), and 3214. That is, in this example, using such iterative processing, the server compares the “b” in the trig vis-à-vis each of s, p, b, t, c, and b—i.e. the first letter of each bin. The dashed line of FIG. 32 reflects this respective comparison of the first letter in the bins in the user's bin collection. After processing the “b” of books in step 3212 and step 3213 (and identifying such as a PBAC), the processing will yield a “no” in step 3214, i.e. since “books” is the last bin (in the user's bin collection).

Thus, upon “no” in step 3214, the process passes to step 3215. In step 3215, the server determines whether there is more than one PBAC. In this example, upon completion of the first pass through the bin collection (with the first letter of each bin name), the server will identify that there are two PBACs, i.e. the “broadway” bin and the “books” bin. Accordingly, the process passes from step 3215 to step 3218. In step 3218, the server advances to the next letter in the bin label in the trig, i.e. the letter “o”. Specifically, in step 3218, the server retrieves the next letter in the bin label (from the trig) and assigns such as the current label letter (CLL), AND the server retrieves the next letter from the first bin (in the user's bin collection) and assigns such as the current bin letter (CBL).

The server then iteratively performs the processing of steps 3212, 3213 (if match), 3214, and 3216 for each bin now being considered, i.e. each PBAC. Accordingly, from the processing described above, the bins songs, people, to-do, and catchall will be eliminated as PBACs. Thus, the server will move on to compare the “o” (the second letter in the trig from the user) with the second letter from the user's bins still under consideration: broadway and books, i.e. “r” and “o” respectively. After such two comparisons, “broadway” will no longer be a PBAC due to a “no” match (step 3212) between the “o” in the trig vis-à-vis the “r” of broadway.

Also, after such two comparisons, the processing will yield a “no” in step 3214, i.e. since there were only the two bins (broadway and books) still under consideration. Thus, the process will pass to step 3215.

In step 3215, the server 200 determines that there is only one PBCA. Thus, the process passes to step 3217. In step 3217, the server adds the text message content “ add@bo—Tale of Two Cities” to the user's “books” bin. Thus, the fuzzy logic processing has successfully identified the desired bin in which to place the content.

As shown in FIG. 32, step 3217 reflects a situation in which there was not a match identified. For example, if the user had submitted the text message content “add@movie ironman2 must see”, the server 200 would not have identified a bin (in the bin collection of FIG. 32), and thus the text message content would have been placed in the “catchall” bin.

It is appreciated that FIG. 32 is one methodology by which to analyze a trig (and specifically the “bin label” in such trig) from a user—in order to identify a corresponding bin in the user's bin collection, in which to place the text message content. Other methodologies may of course be used including various known search and comparison methodologies. In particular, searching algorithms may be utilized, such as sequential searching in which all the items in a data structure are examined until the desired item is located; and/or binary searching in which a previously sorted list of items is progressively divided in half until the desired item is located.

Accordingly, the invention is not limited to that methodology set forth in FIG. 32. Also, the fuzzy logic processing of FIG. 32 is not limited to bin labels, but could also be applied to other strings of characters, such as a “command” in a trig, for example.

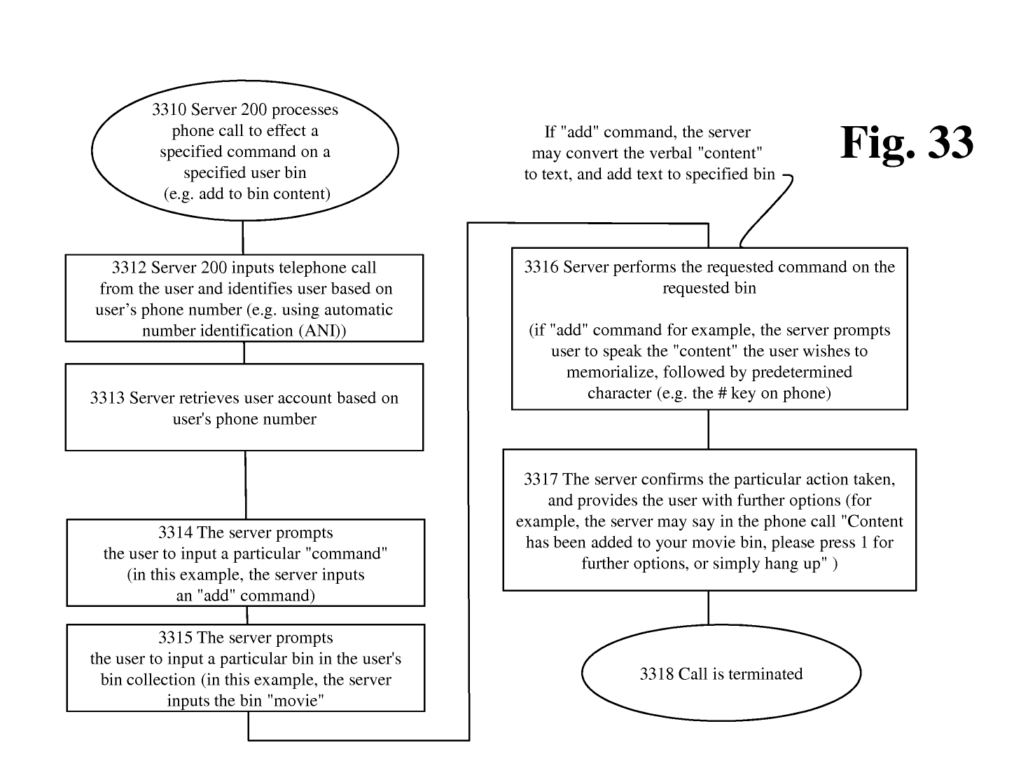

In accordance with further features of the invention, FIG. 33 is a flowchart illustrating server processing of an incoming telephone call in accordance with one embodiment of the invention. In particular, FIG. 33 illustrates the server processing a phone call to effect a specified command on a specified user bin. Accordingly, FIG. 33 illustrates processing in which the user's bin are manipulated using a different communication channel, i.e. the telephone. The process of FIG. 33 starts in step 3310 and passes to step 3312.

In step 3312, the server 200 inputs a telephone call from the user and identifies the user based on the user's phone number (e.g. using automatic number identification (ANI)). Then, in step 3313, the server retrieves the user's account based on the user's phone number. After step 3313, the process passes to step 3314.

In step 3314, the server prompts the user to input a particular “command.” In this example, the server inputs an “add” command. For example, the server might verbalize to the user, via the phone call:
Please select the command you wish to activate. To add content to one of your bins press 1, to send content from one of your bins press 2, to clear content from one of your bins press 3, to create a new bin in your bin collection press 4, to delete a bin in your bin collection press 5.

After step 3314, the process passes to step 3315. In step 3315, the server prompts the user to input a particular bin in the user's bin collection. In this example, the server inputs the bin “movie” from the user. Such input of a particular bin (in the user's bin collection) might be performed in the same manner as the user selected the command, i.e. the server verbalizes the bins to the user followed by a particular number to select. For example, the server might electronically verbalize:
Please select the bin in your bin collection you wish to use. For your song bin press 1, for your people bin press 2, for your broadway bin press 3, . . .
   After the user has selected the particular bin in step 3315, the process passes to step 3316.

In step 3316, the server performs the requested command (as determined in step 3314) on the requested bin (as determined in step 3315). If the requested command is an “add” command, as in this example, the server prompts the user to speak the “content” the user wishes to memorialize, followed by a predetermined character (e.g. the # key on phone). Accordingly, the server inputs the spoken content the user wishes to memorialize. To demarcate the end of the spoken content, the server detects the user pressing the # key on her phone. Then, the process passes to step 3317.

In step 3317, the server confirms to the user the particular action taken, and provides the user with further options. For example, the server may verbalize in the phone call “content has been added to your movie bin, please press 1 for further options, or simply hang up.” Then, in step 3318, the call is terminated—“At-It thanks you for your add message.”

Accordingly, the user may add content to a bin, pull content from a bin, or perform other manipulation of the bins (in the user's bin collection) via a telephone call, and in particular, for example, by calling the server 200 and interfacing with the server using the keypad on the user's telephone, or equivalent voice recognition capability by the server.

In accordance with embodiments of the invention, as described above, it is appreciated that e-mail communications may also be leveraged by the features of the invention. In accordance with embodiments of the invention, the subject line of an e-mail message (and/or the body of an e-mail) may be designated to function in the same manner as a text message, as described herein. Accordingly, for example, upon receiving an e-mail from the user, the server identifies the user based on his or her e-mail address. The server then looks to the subject line and/or the body of the e-mail to identify a trig. Further processing may then be performed (based on that trig) in manner similar to text message processing as described herein.

As described above with reference to FIG. 28, report messages may or may not include trigs. FIG. 34 is a diagram showing further aspects of trig presentation in a report message from the server 200, in accordance with one embodiment of the invention.

As described above, the server sends a report message in response to a send message. In accordance with embodiments as shown in FIG. 34, the server 200 may reposition trigs that are included in the content of the report message.

In general, in accordance with embodiments of the invention, the server 200 may reposition trigs in communications to or from the server 200. To explain, in some embodiments of the invention, and in particular with add messages, it does not matter where the user places the trig in the text message. Regardless of whether the trig is placed in the beginning or the end, or the middle, the server 200 simply identifies the trig based on identifying the trick (in a character string in the text message). The server 200 then performs processing based on that trig, parsing both the “command” and the “bin label”. As described herein, there may also be secondary trigs in a text message, which the server processes in conjunction with a primary trig.

Relatedly, the server 200 may reposition trigs that are included in the content of an add message (received from the user). For example, the server may move the trig in each text message to a desired location. The user may specify, by user preference, that she always wants trigs at the end of each bin-content item (in report messages from the server), for example. Such might be desirable in that the non-trig content would then be pushed to the end of the particular bin content item. Alternatively, the trig might always be repositioned by the server 200 to be positioned at the beginning of a particular bin-content item.

The trig in a bin content item might be repositioned prior to being added to the bin, prior to being forwarded out to the user in a report message, or at some other desired time. In conjunction with the user viewing her bin content via webpage or mobile application, the trigs might be hidden from view of the user, until the user clicks a suitable button indicating she wants to see the trigs.

Accordingly, as noted above, FIG. 34 is a diagram showing further aspects of trig presentation in a report message from the server 200. In accordance with one embodiment of the invention, the GUIs of FIG. 34 might be presented on the text messaging tool of a smartphone, for example. The GUI 3410 shows the trig position maintained in each bin-content item.

The GUI 3412 illustrates a report message in which the server has adjusted the position of the trigs in each bin-content item. Specifically, the server has moved each of the trigs to the end of its respective bin-content item. The positioning may be adjusted as desired

The GUI 3414 illustrates a report message in which the server has deleted all trigs from each bin-content item. However, the server has placed a master trig indication at the end of the report message. Specifically, the server has inserted the character string “ALL add@movie” to indicate that each bin-content item in the report message possesses the same trig. This may, in general be the case, i.e. since such same trig controlled placement of the content into the bin, i.e. upon receiving the respective initial “add message” from the user.

The GUI 3416 illustrates a report message in which the server has deleted the trigs in each bin-content item. The GUI 3416 may be preferable to some users since it might be seen to present the cleanest presentation of content.

It is appreciated that the respective presentations of content shown in FIG. 34 may be presented using the messaging tool of a smartphone, via web page or via mobile application, for example.

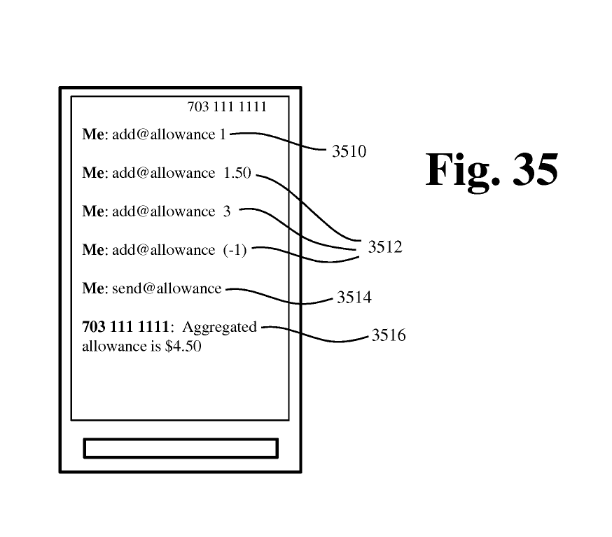

FIG. 35 is a GUI illustrating an allowance adder, in accordance with one embodiment of the invention. The allowance adder utilizes a special purpose bin, which is adapted to process trigs, received from the user via text message, in a particular manner.

As shown in FIG. 35, the user sends a first text message 3510 to the server “add@allowance 1”. In response to receipt of the text message from the user, the server determines that the trig maps into the allowance bin of the user's bin collection, i.e. based on the bin label. The allowance bin is a special purpose bin that performs specialized processing. In this example, the specialized processing that the server is programmed to perform is to input the non-trig content (that is sent with an add@allowance trig), and to sum that non-trig content with previously submitted content, i.e. sum in the mathematical sense. As reflected in FIG. 35, such summation can include summing negative numbers.

Accordingly, the processing as depicted in FIG. 35 may be used as a tool to keep track of the allowance due to a child. For example, once the child completes a household task or in some other way earns $1, the parent sends the text message 3510 to the server. As noted above, the server processes the text message by summing $1 with any monies already summed in the allowance bin (of the user's bin collection). The text messages 3512 reflect further summing based on activity of the child. For example, the “add@allowance (−1)” may have been sent upon the parent paying $1 for a toy at some point in time, i.e. such that the child's allowance balance should be reduced by that value.

At some further point in time, the user decides she wishes to have the total summation, i.e. the balance in the allowance bin. Accordingly, she crafts and sends a text message 3514 to the server—“send@allowance”. In response, the server sends a report message 3516 to the user—“Aggregated allowance is $4.50”. Accordingly, leveraging text messaging that is readily accessible via the user's phone, the server 200 is adapted to perform processing to assist a parent with tracking his or her child's accumulation of allowance money. It is appreciated that a trig of different content, such as “add@allowance-rb” might be used to distinguish one child from another, i.e. in the situation where there are multiple children, and a respective allowance bin is dedicated to each child. Alternatively, a secondary trig might be utilized to uniquely identify a child vis-à-vis other children of the user.

It is appreciated that other bins may be provided by the server 200 that provide other specialized processing. In particular, such bins may be adapted to process the content of text messages in a particular manner, so as to yield a particular processing tool to the user.

In accordance with one embodiment of the invention, the At-It system and the processing as described herein might be conducive to gaming features. For example, a user might be presented with a data sheet of information. The user is tasked with segregating that information in some manner, sending the information (via send message) to appropriate bins in the user's bin collection, and then pulling that information out in some manner via report message. Third persons might be involved in the game, with the objective (of the user) to convey the information to such third persons in some logical manner. Such processing might be timed in some manner and the user ranked based on his or her performance. Such ranking might be used in the user's complexity score, as described herein. In summary, the user may be presented with a list of content, and the object of the game is to see how fast she can add that content into bins, and then pull out such content—to attain some objective. Various variations are within the scope of embodiments.

In accordance with one embodiment of the invention, the server 200 may monitor the pace at which the user adds content to her bins. That is, the user might tell the server 200, via a suitable dialogue box or text message, that she wants to add 5 songs to her music bin every week, for example. This might be desired by the user who wants to keep up with new songs coming out and/or in general to increase her iTUNES collection, for example. The server monitors each add message from the user that adds content to her music bin. In other words, the server 200 monitors how many add@music text messages the server has received from the user. At the end of the week, the server tells the user her status, and whether she is on pace. It is of course appreciated that any period of time might be utilized and the pace determined in any suitable manner, as desired. In general, such feature relating to the pace of additions to a particular bin may provide a useful tool in enriching a particular area of the user's life at a set pace. For example, every time the user takes a notable picture of her son, the user might text an add message to a suitable bin (in his bin collection) documenting such picture. If the user has specified to the server 200 that this should happen once a month, then the server 200 will text the user if such bin has not been added to at the end of a particular month, i.e. indicating that the user has not taken a notable picture of his son that week, and so that the user can remember to do so.

In accordance with one feature of the invention, a user may be assigned a complexity score, i.e. a ranking, as to the complexity of his or her use of the At-It system 10. In a fun and friendly competitive manner, the user might share her complexity score with friends, for example. The complexity score might be output to the particular user's social networking web page, for example, such that friends could view the score. The complexity score might also be characterized as a “thought tool score.”

The complexity score might be based on and/or factor in a variety of parameters such as the number of text messages processed for the user by the server 200, the number of bins in the user's bin collection, the pace at which content is added to bins, the use of folders and sub-bins, the number of other users interfacing with the user's bin collection, the use of secondary trigs, the use of trig-map items, the use of fuzzy logic, as well as other parameters.

Relatedly, the server 200 may control functionality provided to the particular user based on the user's complexity score. For example, a new user with a low complexity score may not be provided with some functionality, such as use of secondary trigs in a text message to the server 200. Such ranking of how complex the user's use of the system is, and affording functionality based on such complexity ranking, may be helpful in avoiding frustration in a new user. That is, such might avoid giving a new user too much functionality, with which he or she is not familiar, and with which the user becomes frustrated.

In accordance with one embodiment of the invention, the ranking of a user, as to how complex a user is, might be correlated with a “level” in the At-It system 10. As the user works more with the At-It system 10, the user becomes a more complex user, and as a result, the user advances in level. The interrelationship between player experience and level advancement is of course known in the gaming environment. In accordance with one embodiment, the user may designate what level he or she wishes to belong to—in the At-It system. Such would place the user in further control of the sophistication of the At-It system 10 processing, which he or she is working to manipulate and use. Accordingly, if the user did become frustrated, the user would know that it was his or her decision to subscribe to the more complex processing, and thus hopefully mitigate the user's frustration.

In accordance with one embodiment of the invention, the server 200 provides a reminder feature. Illustratively, the user sends a text message to the server 200. The content of the text message is: “remind@3pm6/15/2011remember drill bit at homedepot for kid's wood pyramid”.

Such text message is in a predetermined format and content that the user knows, and that the server 200 is programmed to understand. The text message tells the server 200 that the server should place the text message in queue, e.g. in a “reminder bin” and upon Jul. 15, 2011 at 3 pm, the server 200 sends the user back the very same content that was received. Such might be very helpful in a situation where the user knows that on Wednesday afternoon, he will be near the HOME DEPOT so that he can pick up the needed item, or for remembering any other task. Accordingly, it is appreciated that the server 200 may be utilized, using predetermined text messages, to provide a reminder at a desired future time. Instead of a particular date and time being specified, as in the example above, the user might simply specify a time period. For example, the user might specify that in 3 hours she wishes to be forwarded back content. Accordingly, such feature might be helpful in the situation that the user is out and about, remembers she needs to water the plants when she gets back, and sends a text message to the server 200: remind@3hours water plants. The user might specify any desired time period. The server 200 is programmed to know that, in response to such text message, the server 200 is dictated to push that content back to the user in 3 hours. Later, at home, the user hears the ping of her smartphone indicating receipt of the text message from the server 200. The user might not even need to look at the text message “remind@3hours water plants”. Rather, the user will simply remember—“oh that's right, I need to water the plants.” Accordingly, in a few quick key strokes, in sending the initial text message to the server 200, the user has provided herself a reminder of a needed task.

As described herein, the user may, in general, vary the particular channel that communications are output from the server 200. Accordingly, it is appreciated that the user may control the particular channel that a reminder is output from the server 200. Thus, a reminder might be output via text message, e-mail, or phone call, for example, or via some other channel.

In accordance with one embodiment of the invention, the At-It system 10 provides a reminder feature in conjunction with a particular bin. For example, through user interface with the server 200, the user may tell the server she wants a particular bin's content to be output to her at a particular time. For example, if a friend's (Jacob's) birthday is on December 9, the user may specify that she wishes the server to output all content from her “Jacob-bday” bin on December 1. That is, the user specifies that she wants a “report message” (see FIG. 4) on December 1 that reports all content from her “Jacob-bday” bin. Such feature allows the user to contribute to her “Jacob-bday” bin throughout the year (as she sees items that Jacob might like) and then receive all that content, which she has collected, on December 1. She thus is pushed useful, insightful information, in a timely manner, she has collected over the year, to effectively purchase a gift for Jacob's birthday.

In accordance with one embodiment of the invention, a particular bin may have further reminder functionality associated with the particular bin. This functionality might be controlled by user preference as reflected in parameters contained in the processing particulars (see FIG. 10) of a particular bin. For example, the user might create a particular bin called “childchart” in which the user wants to memorialize the height and weight of her baby every month, as well as to remind her to take a picture. In other words, she has a particular objective in life that she wishes to attain using a particular bin in her bin collection. For the bin called “childchart,” the user might set her user preferences to dictate that such bin “childchart” should be sent an “add” text message every month. The processing particulars associated with the childchart bin may further specify that if the server 200 does not receive a text message each month, then the server 200 sends a text message to the user as a reminder. The processing might provide for how aggressive the server 200 should be in terms of reminders. For example, if the user wants to be absolutely sure she remembers to document her child's height and weight every month, then she might set her user preferences to be very aggressive in reminding her to do so. For example, her user preferences might dictate that the server 200 should send her an initial reminder at the end of a month (in which no “add message” was received) followed by more frequent follow-up reminders. On the other hand, if the user just wants to document the information from time to time, then she might set her user preferences to just send a single reminder, and no follow-up reminders.

In such processing in this example, it is of course appreciated that the server 200 does not “know” the particular purpose for which the user wishes to have the monthly reminder, i.e. to record the growth of her child. The server 200 also does not know that the user will also use her interaction with her bin collection to also remind her to take a picture of her child, for example. Rather, the server knows that it should receive an add message in the user's “childchart” bin, and if the server does not, then the server 200 knows to send a reminder to the user, as well as follow-up reminders if the user has so specified in her preferences.

In accordance with one embodiment of the invention, the reminder functionality may involve communications to multiple persons. That is, in the example above, the user wanted to be reminded to document her child's height and weight every month. In a different scenario, a first person (the user) might be in a position to text information to the server 200, whereas a second person wants confirmation that the first person has indeed done so. For example, it might be the situation that a parent wants confirmation that her son has sent a certain number of text messages to a created bin—the user's “senior-year” bin (so as to document the user's senior year in high school). Accordingly the server 200 processes text message vis-à-vis the son as depicted in FIG. 2, i.e. with add and send messages. However, in addition, the server 200 sends predetermined metrics to the parent (such as how many add messages have been sent by the son to the senior-year bin, and the date of those messages) so that the parent can know the son is documenting his senior year in a desired manner. In this example, the parent is provided only with the metrics, e.g. how many add messages have been processed by the At-It server 200 and added to the senior-year bin, and not with the actual content of those text messages to/from the server 200.

In accordance with one embodiment of the invention, as controlled by user preference, the aggregation of content into a particular bin triggers particular processing to occur. For example, the user might dictate the server 200 to generate a report message after ten add messages have been sent to a particular bin in the user's bin collection, after which the content in the particular bin is deleted. Other automated processing may be provided.

A further example is that the At-It server 200 (through programming and user preference) automatically sends the contents from her “movie” bin to smartphone every Friday night at 5:45 pm. Such is related to the reminder features as described above. Illustratively, as the user is driving home from work, she hears the ping of a text message hitting her smartphone and remembers, based on the ping at 5:45, that she needs to drop by BLOCKBUSTER since it's movie night. That is, without looking at her smartphone, she knows the text is her movie reminder from At-It. Once at BLOCKBUSTER, she pulls out her DROID, for example, and sees the text message from the At-It server 200. The text message shows all the movies she has added to her movie bin over the last week, and prior thereto, or over some other desired time period.

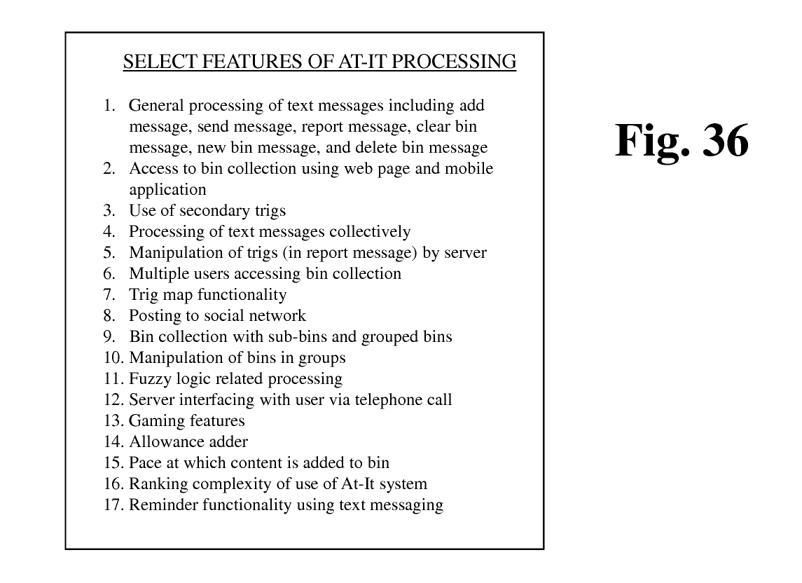

FIG. 36 is a table showing select features of the At-It processing as described herein in accordance with one embodiment of the invention. Various features are described herein which are not listed in FIG. 36. However, FIG. 36 provides a sampling of the functionality afforded by the At-It systems and methods, as described herein.

As described in detail herein, in embodiments of the invention, the user sends and retrieves content from his or her bin collection stored in the server 200. It is appreciated that the invention may be leveraged by the user in a wide variety of ways above and beyond the actual computer processing and related manipulation of data described herein, i.e. “existential uses” as characterized herein. Illustratively, the user sends a text message to his “shop” bin with the text: add@ shop remember to see list in wallet when go to HOME DEPOT. A week later, the user decides to stop in at HOME DEPOT, and retrieves the content from his shop bin, i.e. the user sends a text message to the server 200: send@ shop. The server 200 replies by sending the user back all content from the shop bin, including the user's message “add@ shop remember to see list in wallet when go to homedepot”. Thus, the user is reminded that he had indeed tucked a list in his wallet, and that the user should refer to that list for some needed items.

In a further example, a user might hear a good song being played and simply want to remember the time and occurrence of that song. Accordingly, the user might craft and send a text message to the At-It server 200: 12:12-23 pm07222011 Hearing—Don't Stop Believing—great song add@music.

Accordingly, content forwarded back to the user from the server may convey substantial meaning to the user, above and beyond the actual content of the text message, limited only by the mental abilities of the user and the processing capabilities of the At-It server. In one aspect, the invention forces a categorization of thoughts that are forwarded to the server 200 using add messages, which may be highly desirable for some users. Relatedly, a few words in a text message may remind the user of an entire experience, which he or she might write down or otherwise capture at some more convenient time in the future. In such manner, the invention provides a highly useful tool, literally at the tip of a user's fingers, by which the user may capture life's memories, remind the user of needed tasks, and provide various other information. One objective of the invention is to pull information out of life's activities as easily as possible, and to store that information for later use. A memorable moment at a party might well disappear from thought in a matter of minutes, unless captured in some manner. In accordance with embodiments of the invention, such capabilities are provided by the server 200 in conjunction with the user's mental prowess, using text message technology.

Hereinafter further aspects of implementation will be described.

As described above, embodiments of the system of the invention and various processes of embodiments are described. The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example. As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

What is claimed is:

1. A system that processes text message content from a user device of a user, the user being a human, the user device assigned a routing character string, the system in the form of a tangibly embodied computer, the system comprising:
a communication portion that inputs an electronic text message from the user device, the electronic text message including text message content and the routing character string, and
the text message content constituted by data generated as a result of, and representative of, characters keyed in to the user device by the user, the text message content including a trig, and
the trig including a character string of characters in which at least one of the characters is a trick, the trick being a single predetermined character that identifies the character string as the trig, and the trig further including a command and a bin label, and
each of the trick, the command and the bin label having been keyed in by the user to the user device and represented in the electronic text message, input by the communication portion, as such; and
a processor portion that maintains a bin collection for the user, the bin collection including a plurality of bins, the processor portion performing processing on the text message content including:
identifying the user and the bin collection of the user based on the routing character string;
identifying the trig contained in the text message content based on identifying the trick contained in the trig;
based on identification of the trig, identifying the command, the command dictating particular action to be performed by the processor portion;
based on identification of the trig, identifying a bin label in the trig that identifies an identified bin, in the bin collection of the user, upon which to perform the command; and
performing the command on the identified bin, the identified bin being one of a plurality of bins a bin collection of the user.

2. The system of claim 1, the routing character string is a text message number of the user device, the user device being a smartphone.

3. The system of claim 1, the text message constituting an add message that adds the text message content into the identified bin in the user's bin collection;
the processor portion identifying the command as an add command;
the text message content including the trig and non-trig content, the non-trig content constituted by content desired by the user to be output back to the user; and
the performing the command on the identified bin is constituted by the processor portion adding the text message content into the identified bin.

4. The system of claim 3, the processor portion appending time and date data to the text message content in conjunction with adding the text message content into the identified bin.

5. The system of claim 1, the text message constituting a send message that results in bin content being sent to the user;
the processor portion identifying the command as a send command; and
the effecting the command on the identified bin is constituted by the processor portion pulling bin content from the identified bin and the processor portion outputting the bin content to the user.

6. The system of claim 5, the outputting the bin content to the user is constituted by the processor portion sending the bin content to the user device in the form of a text message, such text message constituting a report message from the system to the user device.

7. The system of claim 5, the outputting the bin content to the user is constituted by the processor portion presenting the bin content to the user via a web page.

8. The system of claim 7, the processor portion removing a plurality of trigs from the bin content prior to the system presenting the bin content to the user via a web page.

9. The system of claim 1, the text message constituting a delete message that results in bin content in the identified bin being deleted by the processor portion;
the processor portion identifying the command as a delete command; and
the effecting the command on the identified bin is constituted by the processor portion deleting content from the identified bin.

10. The system of claim 1, the identified bin being maintained by the processor portion as one of the plurality of bins in the bin collection of the user, the bin collection being associated, by the processor portion, with a user account for the user.

11. The system of claim 1, the trig comprised of the command, the trick, and the bin label, the command disposed before the trick, and the bin label disposed after the trick.

12. The system of claim 1, the trig comprised of the command, the trick, and the bin label, the command disposed after the trick, and the bin label disposed before the trick.

13. The system of claim 1, the trig consisting of the command, the trick, and the bin label, the command disposed before the trick, and the bin label disposed after the trick.

14. The system of claim 1, the identifying a bin label in the trig that identifies an identified bin to perform the command upon, as performed by the processor portion, including the processor portion:
comparing the bin label with a plurality of bins in a bin collection of the user; and
identifying a match between the bin label, disposed in the trig in the text message of the user, vis-à-vis one of the plurality of bins in a bin collection of the user.

15. The system of claim 14, the comparing being performed by the processor portion using fuzzy logic, such fuzzy logic identifying the match even though the bin label does not fully correspond with a name of the one of the plurality of bins.

16. The system of claim 15, the comparing being performed by the processor portion using fuzzy logic constituted by the processor portion respectively performing the comparing based only on the first character of the bin label vis-à-vis the first character of the name of each of the plurality of bins in a bin collection of the user

17. The system of claim 1, the processor portion including processing particulars that are associated with each bin, to control performance of the identified command.

18. The system of claim 1, the system further including a network over which the text message is processed, and the user device, the user device being a smartphone.

19. A method for processing text message content from a user device of a user, the user being a human, the user device assigned a routing character string, the method performed by a system in the form of a tangibly embodied computer, the method comprising:
inputting an electronic text message from the user device, the electronic text message including text message content and the routing character string, and
the text message content constituted by data generated as a result of, and representative of, characters keyed in to the user device by the user, the text message content including a trig, and
the trig including a character string of characters in which at least one of the characters is a trick, the trick being a single predetermined character that identifies the character string as the trig, and the trig further including a command and a bin label, and
each of the trick, the command and the bin label having been keyed in by the user to the user device and represented in the electronic text message, input by the communication portion, as such; and
maintaining, by the processor portion, a bin collection for the user, the bin collection including a plurality of bins, the processor portion performing processing on the text message content; and
the method further including performing such processing including:
identifying the user and the bin collection of the user based on the routing character string;
identifying the trig contained in the text message content based on identifying the trick contained in the trig;
based on identification of the trig, identifying the command, the command dictating particular action to be performed by the processor portion;
based on identification of the trig, identifying a bin label in the trig that identifies an identified bin, in the bin collection of the user, upon which to perform the command; and
performing the command on the identified bin, the identified bin being one of a plurality of bins a bin collection of the user.

20. A non-transient computer readable medium that processes text message content from a user device of a user, the user being a human, the user device assigned a routing character string, the system in the form of a tangibly embodied computer, the computer readable medium comprising:
a communication portion that inputs an electronic text message from the user device, the electronic text message including text message content and the routing character string, and
the text message content constituted by data generated as a result of, and representative of, characters keyed in to the user device by the user, the text message content including a trig, and
the trig including a character string of characters in which at least one of the characters is a trick, the trick being a single predetermined character that identifies the character string as the trig, and the trig further including a command and a bin label, and
each of the trick, the command and the bin label having been keyed in by the user to the user device and represented in the electronic text message, input by the communication portion, as such; and
a processor portion that maintains a bin collection for the user, the bin collection including a plurality of bins, the processor portion performing processing on the text message content including:
identifying the user and the bin collection of the user based on the routing character string;
identifying the trig contained in the text message content based on identifying the trick contained in the trig;
based on identification of the trig, identifying the command, the command dictating particular action to be performed by the processor portion;
based on identification of the trig, identifying a bin label in the trig that identifies an identified bin, in the bin collection of the user, upon which to perform the command; and
performing the command on the identified bin, the identified bin being one of a plurality of bins a bin collection of the user.
